(19) United States
(12) Patent Application Publication
(10) Pub. No.: US 2026/0281775 A1
(43) Pub. Date: Sep. 17, 2026

(54) INTER-USER EQUIPMENT CROSS-LINK INTERFERENCE MANAGEMENT

(71) Applicant: Lenovo (Singapore) Pte Limited, Singapore (SG)

(72) Inventors: Majid Ghanbarinejad, Lake Forest, CA (US); Vijay Nangia, Woodridge, IL (US)

(73) Assignee: Lenovo (Singapore) Pte Limited, Singapore (SG)

(21) Appl. No.: 19/469,170

(22) PCT Filed: Mar. 29, 2024
(86) PCT No.: PCT/IB2024/053104

§ 371 Date: Sep. 25, 2025

Related U.S. Application Data
(60) Provisional application No. 63/493,578, filed on Mar. 31, 2023.
(60) Provisional application No. 63/493,588, filed on Mar. 31, 2023.

(51) Int. Cl. H04W 24/10; H04B 17/345; H04L 5/00; H04W 24/08

(52) U.S. Cl. CPC H04W 24/10; H04B 17/345; H04L 5/0051; H04W 24/08

(57) ABSTRACT

Various aspects of the present disclosure relate to inter-user equipment cross-link interference management. A user equipment (UE) receives a sounding reference signal (SRS) configuration for inter-cell cross-link interference (CLI) measurements, where the SRS configuration includes information of joint resource allocation for multiple UEs. The UE also receives a CLI (e.g., SRS-RSRP) reporting configuration. The UE determines which resources of the jointly allocated resources are associated with a UE, or a beam of a UE, and performs CLI measurements on the resources. The CLI results are then reported to the serving cell to be used for scheduling and link adaptation.

### RELATED APPLICATION

This application claims priority to U.S. Patent Application Ser. No. 63/493,578 filed Mar. 31, 2023 entitled “INTER-USER EQUIPMENT CROSS-LINK INTERFERENCE MANAGEMENT,” the disclosure of which is incorporated by reference herein in its entirety. This application also claims priority to U.S. Patent Application Ser. No. 63/493,588 filed Mar. 31, 2023 entitled “BACKHAUL AND OVER-THE-AIR SIGNALING FOR INTER-USER EQUIPMENT CROSS-LINK INTERFERENCE MANAGEMENT,” the disclosure of which is incorporated by reference herein in its entirety.

### TECHNICAL FIELD

The present disclosure relates to wireless communications, and more specifically to inter-user equipment (UE) cross-link interference (CLI) management.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, various data and control information can be communicated from one device to another, such as from a UE to a base station (e.g., a gNB) or from a base station (e.g., a gNB) to a UE. Given the various network communication devices and user communication devices in a wireless communication system and their proximity to one another, situations can arise where these devices interfere with one another when communicating data or control information.

### SUMMARY

The present disclosure relates to methods, apparatuses, and systems that support inter-user equipment cross-link interference management. Generally, the techniques discussed herein provide new signaling that allows inter-UE CLI handling by exchanging a small number of sounding reference signal (SRS) configurations associated with multiple UEs. These techniques reduce SRS resources, and provide joint SRS transmission and CLI measurement by multiple UEs. A UE receives, from a network entity (e.g., a base station), a SRS configuration for inter-cell CLI measurements, where the SRS configuration includes an indication of a set of resources associated with multiple devices (e.g., multiple UEs). The UE also receives, from the network entity, a CLI reporting configuration associated with the SRS configuration. The UE performs a CLI measurement on each of multiple subsets of the resources according to the CLI reporting configuration, where each of the multiple subsets is associated with one of the multiple devices. The UE transmits a CLI report that includes one or more results of the CLI measurements to the network entity. By using the SRS configuration and performing CLI measurements based on the indicated set of resources, inter-UE CLI can be managed in a scalable manner, allowing for SRS transmission and CLI measurement for large numbers of UEs.

Some implementations of the method and apparatuses described herein may further include to: receive, from a network entity, a first signaling indicating a SRS configuration for inter-cell CLI measurements, wherein the SRS configuration includes an indication of a set of resources associated with multiple devices; receive, from the network entity, a second signaling indicating a CLI reporting configuration associated with the SRS configuration; perform a CLI measurement on each of multiple subsets of the resources according to the CLI reporting configuration, wherein each of the multiple subsets is associated with one of the multiple devices; and transmit, to the network entity, a third signaling indicating a CLI report that comprises one or more results of the CLI measurements.

In some implementations of the method and apparatuses described herein, each of the multiple subsets comprises one or more of at least one symbol, or at least one resource element. Additionally or alternatively, the CLI report further comprises indications of associations between each of the one or more results and one of the multiple devices. Additionally or alternatively, each of the multiple subsets is further associated with a transmit beam of one of the multiple devices. Additionally or alternatively, the CLI report further comprises indications of associations between each of the one or more results and a transmit beam of one of the multiple devices. Additionally or alternatively, a subset of the resources associated with a device is determined by: determining a pattern associated with the device, wherein the pattern comprises multiple fields each of which is further associated with one of the multiple subsets; determining, in response to a field in the pattern being equal to a first value, that a resource associated with the field is in the subset; and determining, in response to the field in the pattern being equal to a second value, that the resource associated with the field is not in the subset. Additionally or alternatively, the pattern comprises, or is associated with, a bitmap field; each of the multiple fields is a bit in the bitmap field; the first value is ‘1’; and the second value is ‘0’. Additionally or alternatively, the method and apparatuses receive, from the network entity, a fourth signaling indicating an activation or deactivation associated with at least one of the SRS configuration or the CLI reporting configuration; and in response to the fourth signaling indicating deactivation: not performing the CLI measurements; or not transmitting the CLI report to the network entity. Additionally or alternatively, a subset of the resources associated with a device is determined by: receiving, from the network entity, a fourth signaling indicating a pattern associated with the multiple devices, wherein the pattern comprises multiple fields each of which is associated with one of the multiple devices; determining, in response to a field in the pattern being equal to a first value, that a device associated with the field transmits an SRS; and determining, in response to the field in the pattern being equal to a second value, that the device associated with the field does not transmit the SRS. Additionally or alternatively, the pattern comprises, or is associated with, a bitmap field; each of the multiple fields is a bit in the bitmap field; the first value is ‘1’; and the second value is and ‘0’. Additionally or alternatively, the method and apparatuses receive, from at least one of the network entity or an additional network entity serving at least a subset of the devices, the pattern. Additionally or alternatively, the CLI is a co-channel interference; and each of the one or more results is at least one of an SRS reference signal receive power (SRS-RSRP) or a CLI receive signal strength indication (CLI-RSSI). Additionally or alternatively, the CLI is an adjacent channel interference; each of the one or more results is a CLI-RSSI; and each of the one or more results of the CLI measurements is obtained by: measuring a co-channel interference associated with a device; obtaining an adjacent channel leakage ratio (ACLR) associated with the device; and computing the adjacent channel interference by combining the co-channel interference and the ACLR. Additionally or alternatively, the obtaining the ACLR comprises receiving a message comprising a value of the ACLR. Additionally or alternatively, the computing the adjacent channel interference comprises at least one of: dividing the co-channel interference by the ACLR in a real domain; or subtracting the ACLR from the co-channel interference in a logarithmic or decibel domain. Additionally or alternatively, the apparatus is a UE. Additionally or alternatively, each of the devices is a UE served by at least one of the network entity, or a network entity of a neighboring serving cell. Additionally or alternatively, the CLI report is associated with a physical layer, a medium access control (MAC) layer, or a radio resource control (RRC) layer.

Some implementations of the method and apparatuses described herein may further include to: transmit, to a UE, a first signaling indicating a SRS configuration for inter-cell CLI measurements, wherein the SRS configuration includes an indication of a set of resources associated with multiple devices; transmit, to the UE, a second signaling indicating a CLI reporting configuration associated with the SRS configuration; and receive, from the UE, a third signaling indicating a CLI report that comprises one or more results of CLI measurements performed on each of multiple subsets of the resources according to the CLI reporting configuration, wherein each of the multiple subsets is associated with one of the multiple devices.

In some implementations of the method and apparatuses described herein, each of the multiple subsets comprises one or more of at least one symbol, or at least one resource element. Additionally or alternatively, the CLI report further comprises indications of associations between each of the one or more results and one of the multiple devices. Additionally or alternatively, each of the multiple subsets is further associated with a transmit beam of one of the multiple devices. the CLI report further comprises indications of associations between each of the one or more results and a transmit beam of one of the multiple devices. Additionally or alternatively, the method and apparatuses transmit, to the UE, a fourth signaling indicating an activation or deactivation associated with at least one of the SRS configuration or the CLI reporting configuration. Additionally or alternatively, the CLI is a co-channel interference; and each of the one or more results is at least one of an SRS-RSRP or a CLI-RSSI. Additionally or alternatively, the apparatus is a network entity. Additionally or alternatively, each of the devices is a UE served by at least one of the apparatus, or a network entity of a neighboring serving cell. Additionally or alternatively, the CLI report is associated with a physical layer, a MAC layer, or a RRC layer.

### BRIEF DESCRIPTION OF THE DRAWINGS

FIG. 1 illustrates an example of a wireless communications system that supports inter-user equipment cross-link interference management in accordance with aspects of the present disclosure.

FIG. 2 illustrates an example of combinations among UEs in accordance with aspects of the present disclosure.

FIG. 3 illustrates an example of a timeline of transmission of reference signals that supports inter-user equipment cross-link interference management in accordance with aspects of the present disclosure.

FIG. 4 illustrates an example of a fixed allocation of resource elements (REs) to pattern identifier (ID) numbers that supports inter-user equipment cross-link interference management in accordance with aspects of the present disclosure.

FIG. 5 illustrates an example of a variable allocation of REs to pattern ID numbers that supports inter-user equipment cross-link interference management in accordance with aspects of the present disclosure.

FIG. 6 illustrates an example of an architecture and backhaul interfaces that supports inter-user equipment cross-link interference management in accordance with aspects of the present disclosure.

FIG. 7 illustrates an example of relationship among entities and links in an example system that supports inter-user equipment cross-link interference management in accordance with aspects of the present disclosure.

FIG. 8 illustrates an example of mapping among the new and existing channels that supports inter-user equipment cross-link interference management in accordance with aspects of the present disclosure.

FIG. 9 illustrates an example of over-the-air (OTA) signaling by to a UE that supports inter-user equipment cross-link interference management in accordance with aspects of the present disclosure.

FIGS. 10 and 11 illustrate examples of block diagrams of devices that support inter-user equipment cross-link interference management in accordance with aspects of the present disclosure.

FIGS. 12 through 17 illustrate flowcharts of methods that support inter-user equipment cross-link interference management in accordance with aspects of the present disclosure.

### DETAILED DESCRIPTION

In wireless communication systems, time division duplexing (TDD) refers to the scheme of splitting radio resources among downlinks and uplinks in the time domain. In a TDD system, at any point in time in a given frequency, the base station transmits signals to one or more subscriber devices or vice versa, but typically not both. In conventional cellular systems that employ static TDD, patterns of TDD are fully synchronized and typically identical so as to avoid interference from one network entity (e.g., base station) when transmitting in a downlink to another network entity (e.g., base station) when receiving in an uplink of a nearby cell. However, if dynamic TDD is employed, where different TDD patterns may be used in different cells, the interference from one UE to another may occur, which degrades performance if not addressed by proper inter-UE interference management techniques.

Also in wireless communications system, subband full-duplex (SBFD) refers to the scheme where one or more UEs are configured to transmit uplink signals in a subband on downlink symbols, or vice versa. The one or more UEs may not be expected to have full-duplex capability on the subband, but the network entity (e.g., base station) may support duplexing for communications on the subband.

When dynamic TDD or SBFD are used in a cell, especially with beamforming at millimeter-wave frequencies, interference caused by one UE on another UE may be significant depending on the beamforming configurations at the aggressor UE and the victim UE. For example, if an aggressor UE happens to transmit an uplink signal with a transmit (Tx) beam that is spatially directed toward the victim UE, and the victim UE happens to receive a downlink signal on the same time-frequency resources with a receive (Rx) beam spatially directed toward the aggressor UE, the uplink signal may cause an excessive interference on the downlink signal.

Generally, the techniques discussed herein provide signaling that allows inter-UE CLI handling by exchanging a small number of SRS configurations associated with multiple UEs. One of the issues with the existing CLI framework is that it is not scalable—each UE is expected to receive a configuration associated with any other UE. As a result, the current CLI framework for UE-to-UE CLI management is related to intra-cell scenarios (unless handled otherwise by non-standard-based operations, administration and maintenance (OAM) signal and implementation) and does not address inter-UE CLI. Techniques are proposed herein for reducing SRS resources and providing joint SRS transmission and CLI measurement by multiple UEs.

In one or more implementations, a UE receives an SRS configuration for inter-cell CLI measurements, where the SRS configuration includes information of joint resource allocation for multiple UEs. The UE also receives a CLI (e.g., SRS-RSRP) reporting configuration. The UE determines which resources of the jointly allocated resources are associated with a UE, or a beam of a UE, and performs CLI measurements on the resources. For example, a UE may receive an SRS configuration including information of resources allocated to the SRS and further receive an indication of a bitmap associated with the SRS configuration. The UE determines, based on the bitmap, which symbols to use for transmission of SRS and which symbols to use for CLI measurements. E.g., the UE may use a first set of symbols to transmit SRS if a first bit in the bitmap is equal to one value (e.g., ‘1’), and the UE may use the first set of symbols to measure CLI from other UEs if the first bit in the bitmap is equal to another value (e.g., ‘0’). Measurements on resources associated with an identical UE (or an identical beam of the UE) may be combined for improving measurement accuracy. The CLI results are then reported to the serving cell to be used for scheduling and link adaptation.

Using the techniques discussed herein, inter-UE CLI can be managed in a scalable manner, which allows for SRS transmission and CLI measurement for large numbers of UEs. Accordingly, the techniques discussed herein allow for inter-user data CLI measurement and reporting, which is not addressed in existing CLI frameworks, which improves the performance of the wireless communications system.

Aspects of the present disclosure are described in the context of a wireless communications system. Aspects of the present disclosure are further illustrated and described with reference to device diagrams and flowcharts.

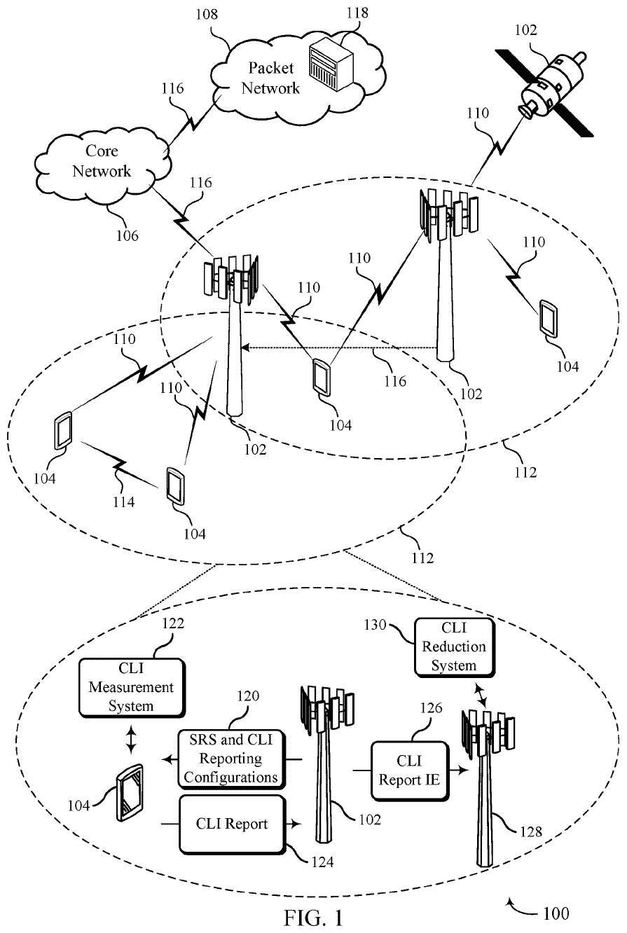

FIG. 1 illustrates an example of a wireless communications system 100 that supports inter-user equipment cross-link interference management in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), a user plane function (UPF)), or a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., u-2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one or more implementations, a network entity 102 transmits an SRS configuration and a CLI reporting configuration 120 to a UE 104. The SRS configuration includes an indication of a set of resources (e.g., symbols) associated with multiple devices. The UE 104 includes a CLI measurement system 122 that performs CLI measurements on each of multiple subsets of resources indicated in the SRS configuration. The UE 104 transmits a CLI report 124 that includes one or more results of the CLI measurements to the network entity 102. The network entity 102 transmits a CLI report information element (IE) 126, obtained from the CLI report 124, to a network entity 128 (which is another network entity 102). The CLI report IE 126 indicates one or more other UEs 104 that cause an excessive CLI for the UE 104, allowing a CLI reduction system 130 of the network entity 128 to coordinate scheduling and beamforming, link adaptation, and so on to reduce the excessive CLI.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

Time division duplex (TDD) can be used in NR deployments. In TDD, the time domain resource is split between downlink and uplink. Allocation of a limited time duration for the uplink in TDD results in reduced coverage, increased latency and reduced capacity. An enhancement on this limitation of the conventional TDD operation is allowing the simultaneous existence of downlink and uplink, also referred to as full duplex, for example, subband non-overlapping full duplex at the network entity (e.g., gNB) side within a conventional TDD band.

NR TDD allows the dynamic or flexible allocation of downlink and uplink in time and CLI handling and remote interference management (RIM) for NR. The techniques discussed herein also take into account CLI handling between the network entities (e.g., gNBs) of the same or different operators to enable the dynamic or flexible TDD in wireless networks. The inter-network entity (e.g., inter-gNB) CLI may be due to adjacent-channel CLI or co-channel-CLI, or both, depending on the deployment scenario. CLI may also be network entity to network entity (e.g., gNB-to-gNB) CLI.

Duplex evolution in the areas discussed above provide enhanced uplink (UL) coverage, reduced latency, improved system capacity, and improved configuration flexibility for NR TDD operations in unpaired spectrum.

In one or more implementations, supporting duplex evolution for NR TDD in unpaired spectrum is discussed herein.

In one or more implementations, the techniques discussed herein assume duplex enhancement at the network entity (e.g., gNB) side. Additionally or alternatively, the techniques discussed herein assume half duplex operation at the UE side. Additionally or alternatively, techniques discussed herein assume no restriction on frequency ranges.

One or more implementations take into consideration at least one of: applicable and relevant deployment scenarios; an evaluation methodology for duplex enhancement; the subband non-overlapping full duplex and potential enhancements on dynamic or flexible TDD; possible schemes and their feasibility and performances; inter-network entity (e.g., inter-gNB) and inter-UE CLI handling and solutions to manage the CLI; intra-subband CLI and inter-subband CLI in cases of the subband non-overlapping full duplex; or the performance of the identified schemes as well as the impact on legacy operation assuming their co-existence in co-channel and adjacent channels.

In wireless communication systems, TDD refers to the scheme of splitting radio resources among downlinks and uplinks in the time domain. In a TDD system, at any point in time in a given frequency, the base station transmits signals to one or more subscriber devices or vice versa, but normally not both. In conventional cellular systems that employ static TDD, patterns of TDD are fully synchronized and typically identical so as to avoid interference from one base station (when transmitting in a downlink) to another base station (when receiving in an uplink) of a nearby cell. However, if dynamic TDD is employed, where different TDD patterns may be used in different cells, the interference from one UE to another may occur, hence degrading performance if not addressed by proper inter-UE interference management techniques.

One duplexing enhancement is subband full-duplex (SBFD) where one or more UEs may be configured to transmit uplink signals in a subband on downlink symbols, or vice versa. The one or more UEs may not have full-duplex capability on the subband, but the network entity (e.g., base station) may have duplexing enhancements for communications on the subband.

When such duplexing enhancements are adopted in a cell, especially with beamforming at millimeter-wave frequencies, interference caused by a UE on another UE may be significant depending on the beamforming configurations at the aggressor UE and the victim UE. For example, if an aggressor UE happens to transmit an uplink signal with a transmit (Tx) beam that is spatially directed toward the victim UE, and the victim UE happens to receive a downlink signal on the same time-frequency resources with a receive (Rx) beam spatially directed toward the aggressor UE, the uplink signal may cause an excessive interference on the downlink signal. This interference may be avoided by proper signaling and coordination among UEs.

A first UE may be provided configuration information of an SRS from a second UE. The first UE may be configured to measure the SRS and report SRS-RSRP to its serving cell. The CLI specification in Rel-16 allows intra-cell UE-to-UE CLI measurement, but includes no specification of inter-cell CLI measurement.

For the purpose of UE-to-UE CLI mitigation, the following potential enhancements are taken into consideration. For L1/L2 UE-to-UE CLI reporting, periodic, semi-persistent, aperiodic reporting are taken into consideration. For L1/L2 UE-to-UE CLI measurement, periodic, semi-persistent, or aperiodic measurement resource is taken into consideration.

For UE-to-UE co-channel CLI handling, enhancing UL power control mechanism is taken into consideration. For example, with existing UL power control mechanism as a baseline

For inter-UE inter-subband CLI measurement, the following is taken into consideration. In one or more implementations, victim UE measures RSSI within downlink (DL) subband is taken into consideration. Additionally or alternatively, victim UE measures RSRP of aggressor UE within UL subband is taken into consideration. Additionally or alternatively, victim UE measures RSSI within UL subband is taken into consideration.

It should be noted that if CLI is only measured within DL bandwidth part (BWP), this does not forbid the UE from measuring CLI in UL subband when UL subband is confined within DL BWP.

One issue to address is that a potentially large number of UEs may be served at a time in a cell. Providing each potential victim UE with configuration information of SRS from an increasingly large number of potential aggressor UEs may become inefficient or impractical. Furthermore, especially in the case of inter-cell inter-UE CLI, it is not clear at each communication which interfering UE is going to interfere. This matter may be further exacerbated if a given aggressor UE uses more than one Tx beam for its UL transmissions.

The number of CLI measurements among multiple UEs is proportional to the number of UEs squared multiplied by the number of potential beams (per UE) squared. This may become a large number in the presence of multiple cells in the vicinity, multiple UEs per cell, or multiple potential beams per UE, which called for proper coordination and allocation of resources at the time of measurement and communications.

Coordinated configurations of reference signals are discussed herein, as well as coordinated scheduling and beamforming. Several additional signaling methods are also proposed such as ACLR indication and backhaul or OTA signaling for communicating semi-static and dynamic information.

When different TDD DL or UL patterns are used between neighboring cells, UL transmission in one cell may interfere with DL reception in another cell: this is referred to as cross link interference (CLI). To mitigate CLI, network entities (e.g., gNBs) can exchange and coordinate their intended TDD DL-UL configurations over Xn and F1 interfaces, and the victim UEs can be configured to perform CLI measurements. Two types of CLI measurements are a SRS-RSRP measurement in which the UE measures SRS-RSRP over SRS resources of one or more aggressor UEs, and a CLI-RSSI measurement in which the UE measures the total received power observed over RSSI resources. Layer 3 filtering applies to CLI measurement results and both event triggered and periodic reporting are supported.

SRS reference signal received power (SRS-RSRP) is defined as linear average of the power contributions (e.g., in [W]) of the resource elements carrying sounding reference signals (SRS). SRS-RSRP may be measured over the configured resource elements within the considered measurement frequency bandwidth in the configured measurement time occasions. For frequency range 1, the reference point for the SRS-RSRP may be the antenna connector of the UE. For frequency range 2, SRS-RSRP may be measured based on the combined signal from antenna elements corresponding to a given receiver branch. For frequency range 1 and 2, if receiver diversity is in use by the UE, the reported SRS-RSRP value may not be lower than the corresponding SRS-RSRP of any of the individual receiver branches. SRS-RSRP may be applicable for RRC_CONNECTED intra-frequency.

CLI Received Signal Strength Indicator (CLI-RSSI), is defined as linear average of the total received power (e.g., in [W]) observed only in the configured OFDM symbols of the configured measurement time resource(s), in the configured measurement bandwidth from all sources, including co-channel serving and non-serving cells, adjacent channel interference, thermal noise, etc. For frequency range 1, the reference point for the RSSI may be the antenna connector of the UE. For frequency range 2, CLI-RSSI may be measured based on the combined signal from antenna elements corresponding to a given receiver branch. For frequency range 1 and 2, if receiver diversity is in use by the UE, the reported CLI-RSSI value may not be lower than the corresponding CLI-RSSI of any of the individual receiver branches. CLI-RSSI may be applicable for RRC_CONNECTED intra-frequency.

With respect to a pattern indication for inter-UE CLI measurements, in order to measure CLI among multiple UEs, each UE is expected to measure CLI from any of the other UEs. In a system of N UEs, if half-duplex technology is adopted, there are N (N−1)=O(N²) different combinations of a first UE transmitting reference signals and a second UE performing CLI measurements on the resources associated with the reference signals.

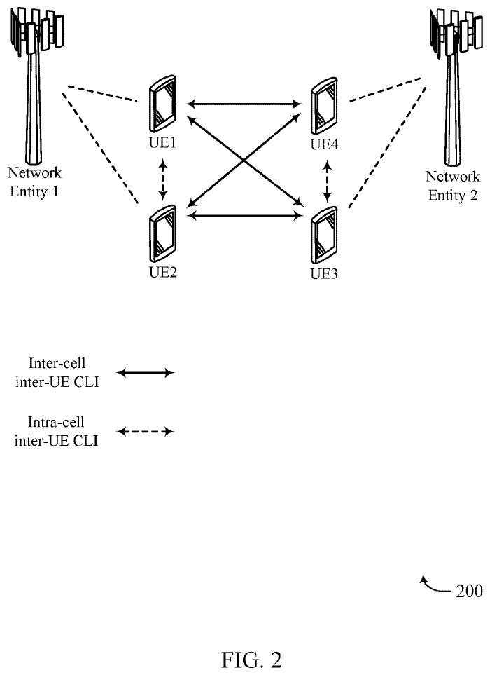

FIG. 2 illustrates an example 200 of combinations among UEs in accordance with aspects of the present disclosure. As illustrated, the number of Tx/Rx combinations among N UEs is O(N²), which may be a potentially large number in urban areas and other crowded places. In the example 200, inter-cell inter-UE CLI is illustrated with solid arrowed lines, and intra-cell inter-UE CLI is illustrated with dashed arrowed lines.

Furthermore, in the presence of beamforming, such as at FR2 or mmWave bands, each transmitting UE may apply M different candidate Tx beams and each receiving UE may apply M different candidate Rx beams, which results in O(M²) combinations of Tx-Rx beam pairs between each two UEs. That yields a total of O(N²M²) reference signals for beam-based CLI measurements among a plurality of N UEs, each applying M candidate beams for a UL Tx or DL Rx. This translates, for example, to the number of symbols required for CLI measurements if each reference signal takes one symbol (per beam per UE), or in general, the resource and latency overhead for CLI measurements.

If the process of CLI measurement is infrequent, the resource and latency overhead may be negligible in the long term. However, UEs may need to perform CLI measurements frequently to take into account mobility, changes in the environment, and so on, that affect the effective channel among the UEs.

There are ways to reduce the overhead below O(N²M²). For example, if multiple UEs perform measurements simultaneously on the same reference signals from a transmitting UE, the number of UE transmissions can be reduced from O(N²) to O(N log N), as discussed in more detail below, which can reduce the total overhead from O(N²M²) to O(M² N log N).

For reducing measurement overhead from O(N²) to O(N log N), consider a plurality of N network entities (e.g., gNBs) in a vicinity. Each network entity is assigned a bitmap of T bits (b_{T-1} . . . b₁b₀)₂, where T is in the order of log₂ N. CLI measurements are performed in T time intervals 0, 1, . . . , T−1, where during each time interval j, each UE with the j-th bit in its assigned bitmap equal to 1 transmits reference signals while each UE with the j-th bit in its assigned bitmap equal to 0 receives the reference signals to perform measurements. Since multiple UEs may transmit reference signals simultaneously, the resources allocated to the reference signals may be multiplexed in the frequency domain (FDM) such that they do not collide.

This method provides that for every two UEs with assigned bitmaps a and b, there is at least one time interval j in which one of the UEs transmits and the other UE receives. Therefore, with T=[log₂ N] CLI time intervals, one may make sure that each channel between any two UEs is measured by at least one of the two UEs. If channels are reciprocal and the UEs may communicate the CLI measurement results, [log₂ N] time intervals are sufficient.

In some situations, communication of CLI measurement results among UEs may not be practical. Therefore, it may be desired to allow each UE to measure the channel to and from any of the other UEs without relying on channel reciprocity. For this purpose, T additional time intervals may be used where in each time interval j, each UE with the j-th bit in its assigned bitmap equal to 0 transmits reference signals while each UE with the j-th bit in its assigned bitmap equal to 1 receives the reference signals to perform measurements. In this case, the first T time intervals may be called the first round and the second T time intervals may be called the second round.

Additionally or alternatively, two consecutive time intervals may be associated with an index j ∈ {0, 1, . . . , T−1}, where in a first time interval, each UE with the j-th bit in its assigned bitmap equal to 1 transmits reference signals while each UE with the j-th bit in its assigned bitmap equal to O receives the reference signals to perform measurements; and conversely, in a second time interval, each UE with the j-th bit in its assigned bitmap equal to 0 transmits reference signals while each UE with the j-th bit in its assigned bitmap equal to 1 receives the reference signals to perform measurements.

The two alternatives are equivalent, namely two rounds of T intervals versus T groups of two consecutive intervals—the order of reference signal transmissions in one is a permutation of that in the other. Therefore, the two alternatives are expected to require a similar amount of time and frequency resources. Other permutations or arrangements of reference signal transmissions may also be used.

By adopting the above method, a total of 2T=2 [log₂ N] time intervals are sufficient for every UE to receive reference signals from any other UE in at least one time interval.

In each time interval, a total of O(M²) reference signal resources (e.g., symbols) may be used in order to measure interference from each of M candidate Tx beams applied by an aggressor UE on each of the M candidate Rx beams applied by a victim network entity (e.g., gNB). Details of Tx/Rx beamforming in each time interval are discussed in more detail below. The total overhead for beam-based CLI measurement among all UEs may then be realized with an overhead of O(M² N log N).

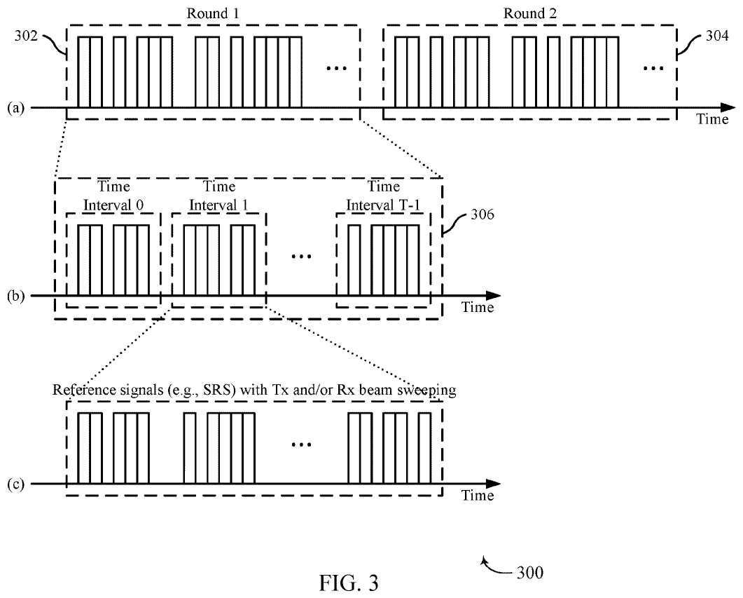

FIG. 3 illustrates an example 300 of a timeline of transmission of reference signals that supports inter-user equipment cross-link interference management in accordance with aspects of the present disclosure. The example 300 illustrates a timeline of transmission of reference signals by multiple UEs according to the methods discussed herein.

The timeline in example 300 is shown based on the two-round alternative-a first round 302 associated with reference signals transmitted by UEs with a 1 in the i-th bit in their assigned bitmap, and a second round 304 associated with reference signals transmitted by UEs with a 0 in the i-th bit in their assigned bitmap. Each round may include T time intervals, which are called resource occasions, as illustrated at 306. Each resource occasion may include reference signal transmissions for Tx and/or Rx beam sweeping. For Tx beam sweeping, a first beamforming configuration or spatial filter on the Tx side may change from one reference signal (resource) to another, while a second beamforming configuration or spatial filter on the Rx side may remain fixed. Conversely, for Rx beam sweeping, a first beamforming configuration or spatial filter on the Tx side may remain fixed, while a second beamforming configuration or spatial filter on the Rx side may change from one reference signal (resource) to another.

A timeline based on other alternative reference signal permutations are essentially similar in principle, except that the order of transmission of reference signals may be different.

In each resource occasion, the plurality of N UEs is partitioned into two groups-Tx UEs, which transmit reference signals in the resource occasion, and Rx UEs, which receive reference signals in the resource occasion and perform measurements on them. In one or more implementations, a UE does not change from Tx mode to Rx mode, or vice versa, within a resource occasion. However, it should be noted that a resource occasion is a concept that may not map into consecutive time resources, e.g., a UE may change from Tx mode to Rx mode between two non-consecutive partitions of a resource occasion. A non-consecutive resource mapping for a resource occasion may be another example of an alternative permutation of reference signals, which is expected to result in a similar amount of time and frequency resources.

With respect to a pattern indication for SRS-RSRP measurement based on the above method, in one or more implementations a UE may receive an SRS configuration including information of resources allocated to the SRS. The UE may further receive an indication of a bitmap associated with the SRS configuration. The UE may receive the bitmap in the SRS configuration or via a separate signaling. The UE may also receive a configuration for a CLI reporting such as SRS-RSRP reporting.

The UE may determine, based on the bitmap, which symbols to use for transmission of SRS and which symbols to use for CLI measurements.

In one or more implementations, the UE may determine 2MT symbols for SRS transmission, where M denotes one or both of the number of candidate Tx beams for SRS transmission or the number of Rx beams for CLI (e.g., SRS-RSRP) measurement, and T denotes the length of the bitmap.

The 2MT symbols include a first plurality of MT symbols and a second plurality of MT symbols. In the first plurality of MT symbols:
the UE may use a first plurality of M symbols to transmit SRS if a first bit in the bitmap is equal to ‘1’, and the UE may use the first plurality of M symbols to measure CLI from other UEs if the first bit in the bitmap is equal to ‘0’;
the UE may use a second plurality of M symbols to transmit SRS if a second bit in the bitmap is equal to ‘1’, and the UE may use the second plurality of M symbols to measure CLI from other UEs if the second bit in the bitmap is equal to ‘0’; . . .
the UE may use a T-th plurality of M symbols to transmit SRS if a T-th bit in the bitmap is equal to ‘1’, and the UE may use the T-th plurality of M symbols to measure CLI from other UEs if the T-th bit in the bitmap is equal to ‘0’.

In the second plurality of MT symbols:
the UE may use a first plurality of M symbols to transmit SRS if a first bit in the bitmap is equal to ‘0’, and the UE may use the first plurality of M symbols to measure CLI from other UEs if the first bit in the bitmap is equal to ‘1’;
the UE may use a second plurality of M symbols to transmit SRS if a second bit in the bitmap is equal to ‘0’, and the UE may use the second plurality of M symbols to measure CLI from other UEs if the second bit in the bitmap is equal to ‘1’; . . .
the UE may use a T-th plurality of M symbols to transmit SRS if a T-th bit in the bitmap is equal to ‘0’, and the UE may use the T-th plurality of M symbols to measure CLI from other UEs if the T-th bit in the bitmap is equal to ‘1’.

For each plurality of M symbols, the UE may apply M different Tx beams for SRS transmission or apply M different Rx beams for CLI measurement. If both Tx and Rx beam sweeping is performed, the method may be modified to use a plurality of M² symbols instead of a plurality of M symbols. If no beam sweeping is performed, the method may be realized by setting M=1.

The UE may transmit a CLI report including the measurement results to a serving network entity (e.g., a gNB). The CLI report may include a plurality of up to N−1 CLI measurement results, e.g., SRS-RSRP values, where N denotes the total number of UEs configured with SRS and CLI reporting. The CLI report may further include indices associated with each of the CLI measurement results. A first index may indicate which UE the CLI report is associated with. A second index may indicate a beam index, such as an integer in the range 0, 1, . . . , M−1.

Additionally or alternatively, the UE may instead determine MT symbols for SRS transmission, where:
the UE may use a first plurality of M symbols to transmit SRS if a first bit in the bitmap is equal to ‘1’, and the UE may use the first plurality of M symbols to measure CLI from other UEs if the first bit in the bitmap is equal to ‘0’;
the UE may use a second plurality of M symbols to transmit SRS if a second bit in the bitmap is equal to ‘1’, and the UE may use the second plurality of M symbols to measure CLI from other UEs if the second bit in the bitmap is equal to ‘0’; . . .
the UE may use a T-th plurality of M symbols to transmit SRS if a T-th bit in the bitmap is equal to ‘1’, and the UE may use the T-th plurality of M symbols to measure CLI from other UEs if the T-th bit in the bitmap is equal to ‘0’.

With respect to resource element (RE) allocation, resources used by different UEs transmitting SRS in a resource occasion may be multiplexed in one or both of time or frequency domains. Either or both of these multiplexing schemes provide resource orthogonality in an OFDM-based communication, which is useful for accurate channel and interference measurements. However, each multiplexing scheme has advantages and disadvantages.

Time-division multiplexing (TDM) allows more frequency resources for each reference signal, hence allowing more accurate measurements. However, the time overhead and latency may be prohibitive. In practice, at most a few REs per resource block (RB) per symbol are allocated to one reference signal.

Frequency-domain multiplexing (FDM) reduces time overhead and latency by allowing multiple reference signal transmissions on one time resource, e.g., an OFDM symbol.

Conventionally, RRC configures and allocates REs for each reference signal. These REs remain typically fixed as long as the configuration is valid. This means that, for example, certain subcarriers in an RB are allocated to an SRS and they do not change over time as long as the SRS configuration is valid.

This fixed RE allocation may be inefficient for at least some of the SRS methods discussed herein. In the methods discussed herein, a number of symbols are configured and allocated to transmission of SRS by multiple UEs in each resource occasion. However, a different subset of UEs may transmit SRS in each resource occasion. For example, in the case that N is a power of 2, N/2 UEs transmit SRS in each resource occasion while the other N/2 UEs may perform measurements on the SRS.

It should be noted that since an SRS may be transmitted on one symbol, the terms subcarrier and RE may be used interchangeably herein.

It should also be noted that in the methods discussed herein, the terms pattern ID number and pattern bitmap may be used interchangeably. However, it should also be noted that a pattern ID number used in the methods discussed herein may be used to determine frequency-domain resource allocations for one or both of SRS transmission or measurement, while a pattern bitmap may be used for time-domain resource allocations. In various implementations, a pattern ID number and a pattern bitmap may be directly associated by a configuration or standard specification. For example, a binary representation of a pattern ID number may be used as a pattern bitmap, or vice versa. Alternatively, a pattern ID number for a frequency-domain resource allocation and a pattern bitmap for time-domain resource allocation may be indicated or determined separately.

In one or more implementations, REs allocated to each UE are fixed. In some examples, the REs may be determined based on a pattern ID number configured for the UE. For example, a UE with the pattern ID number 0 is allocated a first subset of subcarriers, a UE with the pattern ID number 1 is allocated a second subset of subcarriers, and so on. These subsets may be non-overlapping. When a UE transmits SRS on a symbol, the UE uses the allocated subcarriers for the SRS transmission.

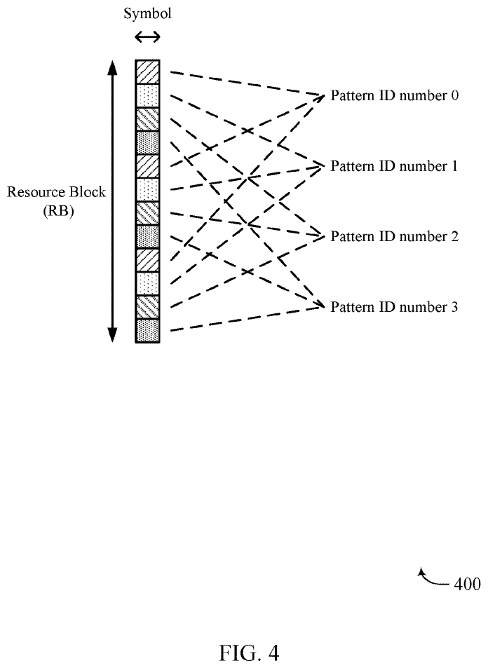

FIG. 4 illustrates an example 400 of a fixed allocation of REs to pattern ID numbers that supports inter-user equipment cross-link interference management in accordance with aspects of the present disclosure. The example 400 illustrates a fixed allocation of REs to 4 pattern ID numbers. REs allocated to pattern ID number 0 are illustrated with diagonal lines from lower left to upper right, REs allocated to pattern ID number 1 are illustrated with a sparse dots, REs allocated to pattern ID number 2 are illustrated with diagonal lines from upper left to lower right, and REs allocated to pattern ID number 4 are illustrated with dense dots.

The UE may not transmit an SRS on certain REs allocated to it for SRS transmissions. One example is when the UE is in the Rx mode in a resource occasion. Another example is when SRS transmission by the UE is deactivated. In this case, different implementations are possible with respect to the UE using the REs. The following are example implementations.

In one or more implementations, the UE may not use the REs and leave them blank, e.g., allocate zero energy or power to a signal on the symbol. Particularly, an uplink transmission by a UE on the symbol or a downlink communication by the UE on the symbol may be punctured at the REs. The transmitter of the signal may perform rate matching around the REs.

Additionally or alternatively, the UE may use the REs for a communication other than an SRS transmission. The UE may use the REs based on determining that the communication does not interfere with a CLI measurement. This realization makes an attempt to use the unused REs for other purposes.

Additionally or alternatively, a gNB may configure, schedule, or trigger an SRS transmission on the unused REs. The SRS may be used for one or both of intra-cell or inter-cell UE-to-UE CLI measurements. Since UEs in the Rx mode are performing measurements on the associated symbols, the UEs may also perform inter-cell interference (ICI) if they are informed of configuration parameters of the reference signals. This may allow a unified CLI, ICI, or channel state information (CSI) measurement by multiplexing SRS and other RS on different REs of a symbol.

Similarly, other UEs in the vicinity may puncture their communications at the subcarriers on the symbol and perform rate matching.

In one or more implementations, a first UE may puncture a communication at the REs on which a second UE is configured to transmit an SRS. The communication may be punctured independent of whether the second UE transmits on the REs in the current resource occasion, e.g., even if the second UE is in the Rx mode in the current resource occasion or if SRS transmission by the second UE is possibly deactivated.

Additionally or alternatively, a first UE may puncture a communication around REs only if a second UE is to use the REs for SRS transmission in the current resource occasion.

With respect to variable allocation, in one or more implementations REs are not allocated to SRS of individual UEs. Instead, each UE determines whether and which REs to use based on configuration information such as a pattern ID number configured for the UE.

In one example, multiple UEs determined to transmit on a symbol, or in a resource occasion including the symbol, are sorted based on their pattern ID number. Then, the first UE in the sorted list uses a first subset of subcarriers, the second UE in the sorted list uses a second subset of subcarriers, and so on. Since the multiple UEs, and consequently the sorted list, are different from one resource occasion to another resource occasion, the subcarriers used by each UE at one time may be different from the subcarriers used by the UE at another time. Nevertheless, provided that the configuration information is provided to the UEs performing CLI measurements, the UEs can determine which REs are associated with which UE without ambiguity.

As a numerical example, consider a plurality of UEs configured with SRS with N=8. The configuration of each UE allocates a pattern ID number between (000)₂ to (111)₂. Assume most significant bit (MSB) first, for mapping from bits to resource occasions, without loss of generality, e.g.: in a 1^{st} resource occasion of a first round, UEs with pattern ID number (1xx)₂ transmit SRS; in a 2^{nd} resource occasion of a first round, UEs with pattern ID number (x1x)₂ transmit SRS; in a 3^{rd} resource occasion of a first round, UEs with pattern ID number (xx1)₂ transmit SRS; in a 1^{st} resource occasion of a second round, UEs with pattern ID number (0xx)₂ transmit SRS; in a 2^{nd} resource occasion of a second round, UEs with pattern ID number (x0x)₂ transmit SRS; and in a 3^{rd} resource occasion of a second round, UEs with pattern ID number (xx0)₂ transmit SRS.

As a result, RE allocation in each of the 3 resource occasions of each round is different. For example: in the 1^{st} resource occasion of the first round, UEs with the following pattern ID numbers transmit SRS (sorted in ascending order): {4, 5, 6, 7}; in the 3^{rd} resource occasion of the second round, UEs with the following pattern ID numbers transmit SRS (sorted in ascending order): {0, 2, 4, 6}.

It can be seen that UEs with pattern ID numbers 4 and 6 transmit SRS in both these example resource occasions, but their position in the sorted list is different. Hence, the subset of subcarriers they use in these example resource occasions is also different.

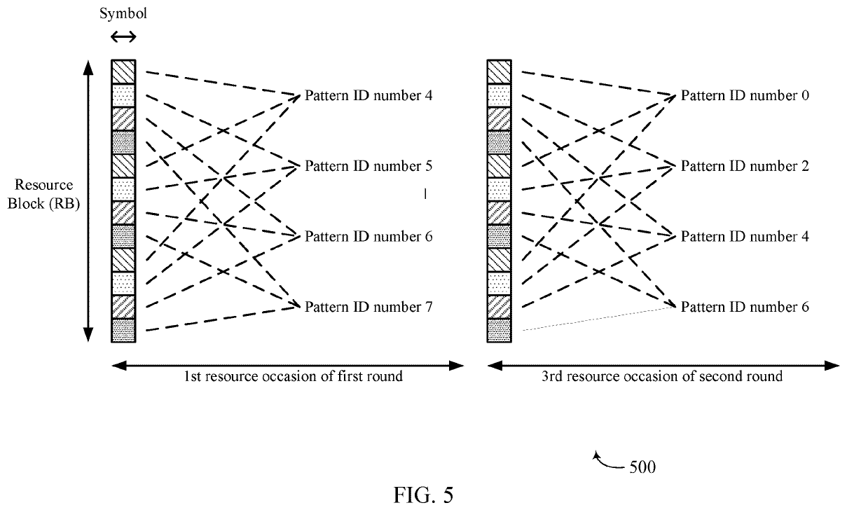

FIG. 5 illustrates an example 500 of a variable allocation of REs to pattern ID numbers that supports inter-user equipment cross-link interference management in accordance with aspects of the present disclosure. The example 500 illustrates a variable allocation of REs to 8 pattern ID numbers. In the 1^{st} resource occasion of the first round, REs allocated to pattern ID number 4 are illustrated with diagonal lines from lower left to upper right, REs allocated to pattern ID number 5 are illustrated with a sparse dots, REs allocated to pattern ID number 6 are illustrated with diagonal lines from upper left to lower right, and REs allocated to pattern ID number 7 are illustrated with dense dots. In the 3^{rd} resource occasion of the second round, REs allocated to pattern ID number 0 are illustrated with diagonal lines from lower left to upper right, REs allocated to pattern ID number 2 are illustrated with a sparse dots, REs allocated to pattern ID number 4 are illustrated with diagonal lines from upper left to lower right, and REs allocated to pattern ID number 6 are illustrated with dense dots.

With respect to configuration of RE allocations, in one or more implementations, for fixed RE allocation, REs (subcarriers) in each RB on a symbol may be allocated to each pattern ID number. This is feasible when the number N of pattern ID numbers is not larger than the number of REs per RB.

Additionally or alternatively, REs (subcarriers) in every 2^{nd} RB, every 3^{rd} RB, etc. on a symbol may be allocated to each pattern ID number. This allows a number N of pattern ID numbers larger than the number of REs per RB.

In one example, such an allocation may be configured by indicating a number of pattern ID numbers. Additionally, the configuration may indicate that REs are allocated in every RB, every 2^{nd} RB, every 3^{rd} RB, or the like.

In another example, a density p of REs per RB may be indicated. If p is larger than or equal to 1, at least one RE per RB is allocated to each pattern ID number. This allocation is possible if N is smaller than or equal to the number of REs per RB. If p is smaller than a 1, an RE in every p-th RB on a symbol is allocated to each pattern ID number.

In these two examples, the configuration may indicate which REs in each RB are allocated to each pattern ID number, for example by indicating a starting RB number, a starting RE number, an ending RE number, or the like. Furthermore, the configuration may indicate whether allocated REs are consecutive or follow a pattern such as a comb pattern.

Additionally or alternatively, the above methods may be extended to the case of variable RE allocation where an N/2 set of REs may be allocated to N pattern ID numbers on a symbol in each resource occasion.

Additionally or alternatively, a combination of the methods may be adopted.

In descriptions of various implementations, a UE may use a pattern ID number to determine which resources to use in time and frequency domains. In the time domain, the UE may use the pattern ID number to determine resource occasions in which it is in the Tx mode or the Rx mode. In the frequency domain, the UE may use the pattern ID number to determine which REs to use according to variable RE allocation methods.

In one or more implementations, a UE may use a same pattern ID number for determining which resources to use for one or both of SRS transmission or CLI measurements in either or both time domain and frequency domain.

Additionally or alternatively, a UE may use a first pattern ID number (or a similar parameter) to determine time-domain resources (symbols) and a second pattern ID number (or a similar parameter) to determine frequency-domain resources (subcarriers or REs) for one or both of SRS transmission or CLI measurements.

With respect to alternative resource pattern parameters, in one or more implementations, a pattern ID number indicated as a cardinal number 0, 1, . . . , N−1 may be used as a ‘bit string’ or bitmap to determine which resources are allocated to SRS of which UE. For example, a value of ‘1’ (or resp. ‘0’) in a bit position (or codepoint) in the pattern ID number may indicate a Tx mode (or Rx mode).

Additionally or alternatively, a resource pattern parameter may include a sequence of bits, a sequence of {′Tx′, ‘Rx’}, or the like, instead of a cardinal number. The sequence may then be used similarly as a ‘bit string’ or bitmap.

With respect to beam repetitions, for beam-based SRS Tx/Rx, a number of SRS (resources) L in each resource occasion may be determined as a function of the number of one or both of Tx or Rx beams of UEs for which the SRS is configured. A number of one or both of Tx or Rx beams may refer to the number per UE, per antenna port, per physical antenna, or the like.

With respect to a symmetric homogenous scenario, consider the case that each of N UEs configured with SRS may apply any of M candidate Tx beams for SRS transmission and any of M candidate Rx beams for SRS reception and CLI measurement. The M ‘candidate’ beams may not be all of the beams the UE supports for one or both of Tx or Rx, but instead they may be the beams that have shown in a CSI or beam acquisition procedure to be suitable for DL or UL communication with the gNB serving the UE.

That results in M² combinations of Tx-Rx beams between each transmitting UE and each receiving UE. This scenario is called symmetric because the number of Tx beams is equal to the number of Rx beams, and it is called homogeneous because the numbers are identical across the UEs.

In this case, L may be set to M² for full Tx or Rx beam sweeping in each resource occasion between Tx UEs and Rx UEs of that resource occasion. The M² beam combinations may take any arbitrary order, but UEs should be aware of the ordering, hence it should be determined based on one or both of specification or configuration.

One ordering may be called Rx-first beam sweeping between any of the Tx UEs and any of the Rx UEs in a resource occasion as follows:
For the 1^{st} M SRS, the Tx UE fixes a 1^{st} Tx beam for transmitting the M SRS, while the Rx UE applies M different Rx beams, each for receiving one of the M SRS;
For the 2^{nd} M SRS, the Tx UE fixes a 2^{nd} Tx beam for transmitting the M SRS, while the Rx UE applies M different Rx beams, each for receiving one of the M SRS; . . .
For the M-th M SRS, the Tx UE fixes an M-th Tx beam for transmitting the M SRS, while the Rx UE applies M different Rx beams, each for receiving one of the M SRS.

Another ordering may be called Tx-first beam sweeping between any of the Tx UEs and any of the Rx UEs in a resource occasion as follows:
For the 1^{st} M SRS, the Tx UE applies M different Tx beams, each for transmitting one of the M SRS, while the Rx UE fixes a 1^{st} Rx beam for receiving the M SRS;
For the 2^{nd} M SRS, the Tx UE applies M different Tx beams, each for transmitting one of the M SRS, while the Rx UE fixes a 2^{nd} Rx beam for receiving the M SRS; . . .
For the M-th M SRS, the Tx UE applies M different Tx beams, each for transmitting one of the M SRS, while the Rx UE fixes an M-th Rx beam for receiving the M SRS.

It should be noted that other types of ordering may be used, but these two orderings may be more practical.

A configuration or specification may indicate whether an Rx-first or Tx-first beam sweeping is to be applied by each UE. This may be indicated by a parameter Beam-Sweeping-Type taking a value from {′RxFirst′, ‘TxFirst’} or the like. Additionally or alternatively, if a parameter repetition is configured, it may be interpreted as indicating Rx-first or Tx-first based on the standard specification.

In this case, the configuration may also indicate one or more of the following parameters: a number of SRS (resources) L, from which a UE may determine a value of M equal to \sqrt{L}; a number of beams M, which a UE may interpret as either or both a number of Tx beam and a number of Rx beams; a number of Tx beams M; or a number of Rx beams M.

With respect to an asymmetric homogeneous scenario, the difference between this scenario and the previous scenario (symmetric homogenous) is that a number of Tx beams Mₜₓ and a number of Rx beams Mᵣₓ may be different. However, the numbers are identical across UEs, hence the term ‘homogeneous.’

In this case, L may be set to MₜₓMᵣₓ for full Tx or Rx beam sweeping in each resource occasion between Tx UEs and Rx UEs of that resource occasion.

Similar to the symmetric scenario, UEs should be aware of how the MₜₓMᵣₓ beam combinations are ordered. Rx-first beam sweeping and Tx-first beam sweeping are defined similarly for the asymmetric scenario, except that the Tx UE applies one of Mₜₓ beams while the Rx UE applies one of Mᵣₓ beams.

In this case, the configuration may also indicate one or more of the following parameters: a number of SRS (resources) L; a number of Tx beams Mₜₓ; or a number of Rx beams Mᵣₓ.

With respect to asymmetric heterogeneous scenario, the difference between this scenario and the previous scenario (symmetric homogenous) is that one or both of a number of Tx beams Mₜₓ or a number of Rx beams Myx may be different across UEs.

In this case, one UE may finish beam sweeping faster than another UE. For example, if UE i has Mₜₓ.i Tx beams and UE j has Mₜₓ, Tx beams, and if Mₜₓ,i>Mₜₓ,j, then in a resource occasion when both the UEs are in Tx mode, UE j may finish Tx beam sweeping faster (e.g., in less SRS transmissions) than UE i.

The bottleneck in this case is the largest number of beams, e.g., the largest number of Tx beams across UEs for SRS transmission and the largest number of Rx beams across UEs for SRS reception and measurement.

Therefore, in one or more implementations, L may be set to MₜₓMᵣₓ, where Mₜₓ is set to the largest Mₜₓ,i across all UEs and Mᵣₓ is set to the largest Mᵣₓ.i across all UEs.

Similar to the previous scenario, UEs should be aware of how the MₜₓMᵣₓ beam combinations are ordered. Rx-first beam sweeping and Tx-first beam sweeping are defined similarly for the asymmetric scenario, except that the Tx UE applies one of Mₜₓ beams while the Rx UE applies one of Mᵣₓ beams.

In one or more implementations, a UE with a smaller number of Tx or Rx beams than the largest may use corresponding resources across all beam sweeping. For example, in a Tx-first beam sweeping, at a UE i with a number of Tx beams Mₜₓ,i smaller than Mₜₓ: if the UE uses the first Mₜₓ, i SRS resources of one set of Mₜₓ SRS resources, the UE uses the first Mₜₓ.i SRS resources of all other sets of Mₜₓ SRS resources; if the UE uses the last Mₜₓ.i SRS resources of one set of Mₜₓ SRS resources, the UE uses the last M_{tx,i} SRS resources of all other sets of Mₜₓ SRS resources.

The configuration may also indicate one or more of the following parameters: a number of SRS (resources) L; a number of Tx beams Mₜₓ; a number of Rx beams Mᵣₓ; a plurality of Tx beams Mₜₓ,i associated with each UE i or pattern ID number i; or a plurality of Rx beams Mᵣₓ,i associated with each UE i or pattern ID number i.

If all UEs are informed of individual M_{tx,i} and M_{rx,i} across all UEs, they may be able to determine a number of SRS resources for each resource occasion by determining which UEs are in a Tx mode and which UEs are in an Rx mode. For example, when a UE with a large number of Tx beams is in an Rx mode in a resource occasion, a smaller number of SRS resources may be allocated to that resource occasion. However, this approach may lead to an excessive complexity not desirable in a practical scenario.

With respect to symmetric heterogeneous scenario, this scenario may be considered a special case of the asymmetric heterogeneous scenario.

With respect to CLI reporting, a UE may be configured to measure and report CLI results such as an SRS-RSRP. The CLI may be measured at layer 3, as specified in Release 16, or at one or both of layer 1 or layer 2 (L1/L2). Then, the UE measures and reports the CLI to a serving network entity (e.g., gNB).

Having received the CLI report, a first network entity (e.g., gNB) may generate a message including one or more of the reported CLI in a CLI report IE. The network entity (e.g., gNB) may then send the CLI report IE to a second network entity (e.g., gNB) serving one or both of at least one aggressor UE or a core network function such as an access and mobility management function (AMF).

A CLI report IE may include one or more CLI measurement fields, each CLI measurement field generated based on a UE-reported CLI and include one or more of the following parameters: a value of interference, such as an SRS-RSRP, associated with an aggressor UE; or an associated beam ID or SRS resource index.

In one or more implementations, a network entity (e.g., gNB) may send CLI report IEs periodically. For example, the network entity (e.g., gNB) may generate and send a CLI report IE at the end of every period of SRS transmission and measurement. More generally, the network entity (e.g., gNB) may generate and send a CLI report at the end of every P periods of SRS transmission and measurement (e.g., at the end of every 2TP resource occasions).

Additionally or alternatively, a network entity (e.g., gNB) may send a CLI report IE when a condition is met. Examples are as follows.

In a first example, if a reported CLI (such as an SRS-RSRP) is above a threshold, the network entity (e.g., gNB) may generate and send a CLI report IE including the reported CLI. The threshold may be determined according to at least one of a configuration signaling among network entities (e.g., gNBs), the core network, or by implementation.

In a second example, if a reported CLI is increased (or decreased) by a value larger than a ‘delta CLI’ compared to an associated previously reported value, then the network entity (e.g., gNB) may generate and send a CLI report IE including the new reported CLI. The ‘delta CLI’ threshold may be determined according to at least one of a configuration signaling among network entities (e.g., gNBs), the core network, or by implementation.

In a third example, if a duration since a last CLI reporting by the network entity (e.g., gNB) is exceeding a CLI report validity expiration threshold, the network entity (e.g., gNB) may generate and send a CLI report IE based on latest reported CLI. The expiration may be computed since the last CLI report IE in general, since the last CLI report IE including a CLI reported by a certain UE, or the like. The CLI report IE validity expiration threshold may be determined according to at least one of a configuration signaling among network entities (e.g., gNBs), or the core network, or implementation.

In yet another implementation, a combination of methods may be adopted. For example, a network entity (e.g., gNB) may send a CLI report IE one or both of periodically or when a condition is met.

With respect to CLI handling, if a network entity (e.g., gNB) receives a CLI report IE, it may take actions to mitigate the adverse effects of CLI by the UE(s) causing excessive CLI. In one or more implementations, the network entity (e.g., gNB) may reduce the UL Tx power associated with the aggressor UEs(s) on all beams or specifically on high-interference beams.

However, if a core network function such as an AMF receives a CLI report, the core network function may send a signaling over the backhaul (e.g., an NG interface) to a network entity (e.g., gNB) serving the UE(s) that cause excessive CLI.

In one or more implementations, the core network may send a UL power control message or IE to a network entity (e.g., gNB) over an NG interface, where the message or IE may include an indication to reduce the UE transmission power by an amount. The indication may apply to all UL transmissions to the network entity (e.g., gNB). In response, the network entity (e.g., gNB) may signal to one or multiple UEs to reduce the UL transmission power by the indicated amount when transmitting a UL signal including the SRS.

Additionally or alternatively, the indication may be associated with a beam ID, an SRS resource indication (SRI), or the like. In response, the network entity (e.g., gNB) may signal to one or multiple UEs to reduce the UL transmission power by an indicated amount when applying a Tx beam (spatial filter) identical to the Tx beam associated with the indicated beam ID or SRI. That UL power reduction may be applied to any or all UL signals including the SRS associated with the beam ID or SRI.

If the UL power control message or IE associates a UL transmission reduction parameter with a beam ID or SRI, the message or IE may include multiple such indications. In response, the network entity (e.g., gNB) may signal to one or multiple UEs to reduce UL transmission power associated with a first SRI by a first amount, reduce UL transmission power associated with a second SRI by a second amount, and so on, as indicated by the message.

In some implementations, a network entity (e.g., gNB) may not be able to comply with an indicated UL transmission power reduction. That may be because, for example, the network entity (e.g., gNB) is to maintain a minimum UL transmission power for communication with the UE(s).

If the network entity (e.g., gNB) is not able to reduce the UL transmission powers by one or multiple indicated amounts, it may send a negative acknowledgement (NACK) message or IE including one or more indications of UL transmission power reduction amounts that cannot be applied. If a smaller reduction amount is possible, the network entity (e.g., gNB) may indicate that amount in the NACK message or IE. Additionally or alternatively, the network entity (e.g., gNB) may send an acknowledgment (ACK) message or IE including one or multiple indications of UL transmission power reduction amounts that can be applied. In some examples, one message or IE may carry one or multiple ACK or NACK indications associated with one or multiple UL transmission power reduction amounts indicated in a UL power control message or IE. No ACK/NACK message or IE may be interpreted as an ACK for the whole UL power control message or as a NACK for the whole UL power control message.

With respect to activation or deactivation signaling, a UE may receive a signaling activating or deactivating one or both of an SRS transmission or measurement. The activation or deactivation message or IE may include one or more of the following parameters: a value of activation or ON, or deactivation or OFF; an indication of association with a SRS transmission configuration, an SRS-RSRP reporting configuration, or the like.

Upon receiving the message, based on whether one or both of SRS transmission or measurement is activated or deactivated, the UE may respectively start or stop one or both of transmitting or measuring SRS associated with the indicated SRS transmission configuration, an SRS-RSRP reporting configuration, or the like.

In some implementations, an activation or deactivation message may be used for starting or stopping both SRS transmissions and SRS-RSRP reporting by a UE.

Furthermore, a gNB may receive a backhaul or OTA signaling activating or deactivating CLI reporting to other network entities (e.g., gNBs) or to the core network. The activation or deactivation message or IE may include one or more of the following parameters: a value of activation or ON, or deactivation or OFF; an indication of association with an SRS configuration; an indication of association with a CLI reporting periodicity or condition parameter.

Upon receiving the message, based on whether CLI reporting is activated or deactivated, the network entity (e.g., gNB) may respectively start or stop sending at least one of CLI report IEs associated with the indicated SRS configuration, CLI reporting periodicity, or CLI reporting condition parameter.

With respect to pattern indication for a large number of UEs, when implementing the methods discussed above it may be assumed that a plurality of time-frequency resources are assigned to a plurality of N UEs for transmitting SRS for the purpose of CLI acquisition.

However, allocation of resources to a fixed set of UEs has drawbacks. In a cell with a large number of UEs that do not communicate frequently, assigning resources to each UE leads to underutilization of a large number of SRS resources or a frequent change of SRS configuration information, which is especially problematic in the case of inter-cell inter-UE CLI because the configuration information is exchanged or updated over the backhaul.

As an alternative, a plurality of time-frequency resources may be used for K UEs, where K may be arbitrarily large, but only a smaller number N of the UEs may be assigned resources from the plurality of time-frequency resources for SRS transmissions. This method aims at reducing resource overhead for SRS transmission without requiring a frequent update of the SRS configuration information among gNBs.

Various implementations work as follows. A second network entity (e.g., gNB) serving potentially aggressor UEs configures one or multiple SRS suitable to accommodate SRS by N UEs. The second network entity (e.g., gNB) sends information of the SRS configurations to a first network entity (e.g., gNB) that serves potentially victim UEs. This information is semi-static and may not be updated frequently. The second network entity (e.g., gNB) may also indicate to the first network entity (e.g., gNB) that as many as K UEs may transmit SRS according to the SRS configurations. The second network entity (e.g., gNB) may then indicate to the first network entity (e.g., gNB) which of the K UEs use which of the resources according to the SRS configurations. The second network entity (e.g., gNB) may indicate a subset of the K UEs including N UEs at any time, where N may be significantly smaller than K. The first network entity (e.g., gNB) may then use the indication for informing UEs in order for them to determine which aggressor UEs' CLI are to be measured. Alternatively, the first gNB may use the information without directly informing the victim UEs.

Further details are as follows.

In one or more implementations, a first network entity (e.g., gNB) may receive an SRS configuration from a second network entity (e.g., gNB), where the configuration message includes a bitmap of length K associated with an SRS configuration, from which a maximum N bits are set to ‘1’. The SRS configuration may allocate any of the following number of symbols according to the methods discussed above: T, 2T, MT, 2MT, M²T, or 2M²T. In each case T may be a bit-width of parameter in the SRS configuration and M may be one or both of a number of Tx candidate beams for SRS transmission or Rx candidate beams for CLI measurements. In some implementations, N may be equal to 2T, or equivalently, T may be in the order of log₂ N.

Each bit in the bitmap may then be associated with 1, 2, M, 2M, M², or 2M² SRS symbols. If a bit is equal to a first value, for example ‘1’, it may indicate that a UE using the associated SRS symbols may transmit an SRS on a configured SRS resource, while otherwise a second value, for example ‘0’, may indicate that the UE may not transmit an SRS on a configured SRS resource. The indication may be associated with a duration, for example a period of P milliseconds, frames, or slots. The value of P may also be indicated in the message.

Additionally or alternatively, a maximum of MN bits are set to ‘1’, where each plurality of M bits may be associated with symbols used by one of N=2^{T} UEs while applying any of M transmit beams.

Additionally or alternatively, the bitmap may include S smaller bitmaps, where each of the smaller bitmaps may be associated with one of K durations of P milliseconds, frames, or slots. The values of one or both of K or P may be configured (semi-static) or indicated (dynamic) between the network entities (e.g., gNBs).

Additionally or alternatively, an indication of aggressor UEs by the second network entity (e.g., gNB) may be transmitted directly to victim UEs via network entity-to-UE (e.g., gNB-to-UE OTA) signaling as discussed in more detail below.

With respect to pattern indication for coordinated scheduling and beamforming, whether SRS-based CLI configurations follow the CLI framework specified in Release-16 or the techniques discussed herein, the SRS-RSRP obtained and reported to the network may be only taken as a worst-case CLI if the victim UE or the network entity (e.g., gNB) scheduling the victim UE does not know when a given aggressor UE is scheduled for uplink transmissions.

In the case of intra-cell inter-UE gNB the matter may be straight-forward—the serving network entity (e.g., gNB) has the scheduling information of the aggressor UE and can use the information for scheduling communication with the victim UE. In the inter-cell case, however, the network entity (e.g., gNB) serving the victim UE does not know when the aggressor UE may transmit uplink signals that may interfere with downlink signals to the victim UE.

In the discussions above, several implementations and examples are discussed based on pattern indication for one or both of transmitting SRS or measuring CLI such as SRS-RSRP. The indicated patterns may be used by the UEs to determine resources assigned to an SRS transmission in one or both of time or frequency domains.

In the following, methods are discussed to indicate a pattern of UL transmissions by the UEs. It should be noted that the pattern indications are distinguished as follows.

The first and second pattern indications discussed above (e.g., the pattern indication for inter-UE CLI measurements and the pattern indication for a large number of UEs) indicate which potentially aggressor UEs use which resources to transmit SRS and/or according to which SRS configuration. These pattern indications may be used for CLI measurements such as SRS-RSRP by one or more potentially victim UEs. The outcome is acquiring information of inter-UE CLI, which may then be used for various CLI handling approaches such as UL power reduction as described earlier.

A third pattern indication discussed in the following indicates which potentially aggressor UE, whose CLI has already been measured by one or more potentially victim UEs, uses which resources to transmit UL signals to its serving network entities (e.g., gNBs). The outcome here is handling CLI by one or both of coordinating scheduling or beamforming among UE communications, specifically UL transmissions by aggressor UE(s) and DL receptions by victim UEs(s).

Various implementations discussed in the following work as follows. A second network entity (e.g., gNB) serving potentially aggressor UEs configures one or more SRS for one or more of N active UEs, K total UEs, or M Tx beams for each UE. The second network entity (e.g., gNB) sends information of the SRS configurations to a first network entity (e.g., gNB) that serves potentially victim UEs. This information is semi-static and may not be updated frequently. The second network entity (e.g., gNB) may also indicate to the first network entity (e.g., gNB) that as many as N or K UEs may transmit SRS according to the SRS configurations. The second network entity (e.g., gNB) may then indicate to the first network entity (e.g., gNB) which of the N or K UEs use which of the resources for uplink transmissions and/or which of the M Tx beams for each UE is applied. The indication may be associated with the SRS configurations(s) explicitly or implicitly. The first network entity (e.g., gNB) may then use the indication for one or both of coordinated scheduling or beamforming.

The following are examples of how the first gNB may use the indication for one or both of coordinated scheduling or beamforming.

Example 1: If a UE1 has reported an excessive CLI from a UE2, and if the second network entity (e.g., gNB) has indicated that UE2 is going to transmit an uplink signal, then the first network entity (e.g., gNB) may avoid scheduling a downlink communication to UE1.

Example 2: If a UE1 has reported an excessive CLI associated with a Tx beam of UE2, and if the second network entity (e.g., gNB) has indicated that UE2 is going to transmit an uplink signal while applying the Tx beam, then the first network entity (e.g., gNB) may avoid scheduling a downlink communication to UE1.

Example 3: If a UE1 has reported an excessive CLI from UE2 while UE1 applies a certain Rx beam, and if the second network entity (e.g., gNB) has indicated that UE2 is going to transmit an uplink signal, then the first network entity (e.g., gNB) may avoid scheduling a downlink communication to UE1 through the Rx beam.

Example 4: If a UE1 has reported an excessive CLI associated with a Tx beam of UE2 while UE1 applies a certain Rx beam, and if the second network entity (e.g., gNB) has indicated that UE2 is going to transmit an uplink signal while applying the Tx beam, then the first network entity (e.g., gNB) may avoid scheduling a downlink communication to UE1 through the Rx beam.

Example 5: If a UE1 has reported an excessive CLI from a UE2, and if the second network entity (e.g., gNB) has indicated that UE2 is going to transmit an uplink signal on one or both of certain time or frequency resources, then the first network entity (e.g., gNB) may avoid scheduling a downlink communication to UE1 on the one or both time or frequency resources.

Examples of time resources are symbols, slots, subframes, frames, a plurality of frames, or the like. The associated information exchanged among network entities (e.g., gNBs) may be semi-static or dynamic.

Examples of frequency resources are carrier, component carrier (CC), BWP, subband, a frequency range, one or more PRBs, or the like. The associated information exchanged among gNBs may be semi-static or dynamic.

Further details are as follows.

In one or more implementations, a first network entity (e.g., gNB) may receive an SRS configuration from a second network entity (e.g., gNB), where the configuration message includes a bitmap associated with one or more of N active UEs, K total UEs, or M Tx beams for each UE. The first network entity (e.g., gNB) may then receive dynamic indication of a bitmap associated with 1, 2, M, 2M, M², or 2M² SRS symbols. If a bit is equal to a first value, for example ‘1’, it may indicate that a UE using the associated SRS symbols may transmit an uplink signal, while otherwise a second value, for example ‘0’, may indicate that the UE may not transmit an uplink signal. The indication may be associated with a duration, for example a period of P milliseconds, frames, or slots. The value of P may also be indicated in the message.

Additionally or alternatively, a maximum of MN bits are set to ‘1’, where each plurality of M bits may be associated with symbols used by one of N=2^{T} UEs while applying any of M transmit beams.

Additionally or alternatively, the bitmap may include S smaller bitmaps, where each of the smaller bitmaps may be associated with one of K durations of P milliseconds, frames, or slots. The values of K and/or P may be configured (semi-static) or indicated (dynamic) between the network entities (e.g., gNBs).

Additionally or alternatively, an indication of aggressor UEs by the second network entity (e.g., gNB) may be transmitted directly to victim UEs via network entity-to-UE (e.g., gNB-to-UE OTA) signaling as described in more detail below.

With respect to an ACLR indication, the focus of the methods discussed above is on co-channel interference, e.g., the interference caused by a signal on the same channel on which it is transmitted. However, adjacent channel interference may also be significant when duplexing enhancements (SBFD, dynamic TDD) are employed.

A main issue with obtaining adjacent channel interference is that it is not as straight-forward to obtain from reference signals. One way to obtain adjacent channel interference is by measuring RSSI, which uses the underlying assumption that one main interferer is causing the interference. Unlike RSRP type interference measurements, RSSI type measurements do not allow distinguishing the contribution of multiple signals with comparable received signal strength. Additionally or alternatively, the adjacent channel interference may be computed by dividing the co-channel interference by the ACLR in a real domain. Additionally or alternatively, the adjacent channel interference may be computed by subtracting the ACLR from the co-channel interference in a logarithmic or decibel domain.

In one or more implementations, an aggressor UE or a network entity (e.g., gNB) serving the aggressor UE may indicate one or more values of adjacent channel leakage ratio (ACLR) to a neighbor network entity (e.g., gNB) or a victim UE it is serving.

In one example, a first network entity (e.g., gNB) may receive from a second network entity (e.g., gNB) an ACLR value corresponding to the worst-case ACLR among a plurality of N UEs. The message from the second network entity (e.g., gNB) may further include an indication of association with an SRS configuration on T, 2^{T}, MT, 2MT, M²T, or 2M²T symbols, where T=log₂ N.

In another example, a first network entity (e.g., gNB) may receive from a second network entity (e.g., gNB) a plurality of N ACLR values, where each ACLR value may be associated with one of the N UEs. The message from the second network entity (e.g., gNB) may further include an indication of association with an SRS configuration on T, 2^{T}, MT, 2MT, M²T, or 2M²T symbols, where T=log₂ N.

In one or more implementations, an ACLR value associated with an aggressor UE may be reported by the UE to the second network entity (e.g., gNB) as a capability parameter. The second network entity (e.g., gNB) may then indicate the ACLR value associated with the aggressor UE, or a worst-case ACLR value associated with a plurality of the aggressor UEs, to the first network entity (e.g., gNB). The first network entity (e.g., gNB) may then combine this information with co-channel interference results, such as SRS-RSRP reported by victim network entities (e.g., gNBs), to obtain adjacent channel interference (such as adjacent channel CLI-RSSI) or a worst-case adjacent channel interference (such as a worst-case adjacent channel CLI-RSSI).

Additionally or alternatively, an ACLR value associated with an aggressor UE may be measured by the second network entity (e.g., gNB). The second network entity (e.g., gNB) may then indicate the ACLR value associated with the aggressor UE, or a worst-case ACLR value associated with a plurality of the aggressor UEs, to the first network entity (e.g., gNB). The first network entity (e.g., gNB) may then combine this information with co-channel interference results, such as SRS-RSRP reported by victim network entities (e.g., gNBs), to obtain adjacent channel interference (such as adjacent channel CLI-RSSI) or a worst-case adjacent channel interference (such as a worst-case adjacent channel CLI-RSSI).

With respect to backhaul signaling vs. OTA signaling, the signaling discussed above (e.g., with respect to an ACLR indication) allows a network entity (e.g., gNB) to coordinate on CLI measurements by the UEs, scheduling and beamforming among UEs in different cells, and so on. Various implementations use signaling among the network entities (e.g., gNBs) for one or both of semi-static configuration information or dynamic signaling.

One candidate for the signaling is backhaul, e.g., an Xn or NG interface. In this case, the message may be an IE including a bitmap of length N, MN, SN, or the like. The IE may further include an indication of association with an SRS configuration, which may be communicated separately over the same backhaul interface.

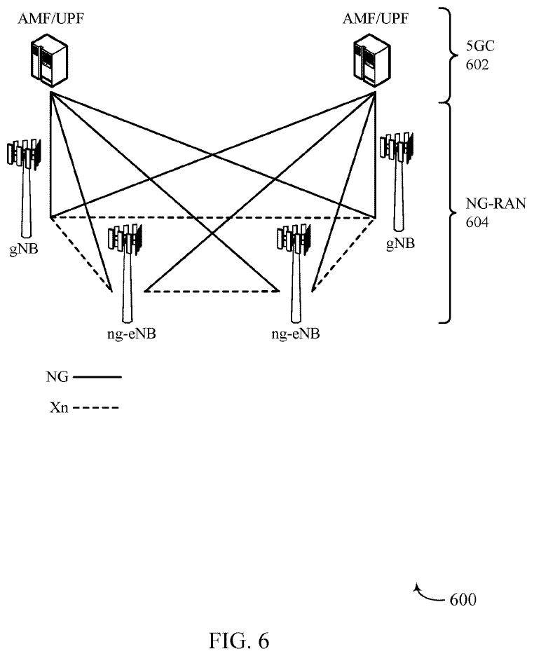

FIG. 6 illustrates an example 600 of an NG-RAN architecture and backhaul interfaces that supports inter-user equipment cross-link interference management in accordance with aspects of the present disclosure. The example 600 illustrates the NG-RAN architecture and backhaul interfaces in 5G NR. NG interfaces are shown with solid lines, Xn interfaces are shown with dashed lines. The example 600 includes AMF or user plane function (UPF) components of the 5G core (5GC) at 602 as well as gNBs and enhanced LTE eNBs (ng-eNB) in NG-RAN at 604.

One issue with backhaul signaling is that the medium may be too slow for communicating such scheduling and beamforming information dynamically. UEs are potentially mobile, and their traffic may be bursty or dynamic. Furthermore, scheduling a large number of UEs may lead to a serving network entity (e.g., gNB) to indicate different candidate Tx beams for uplink transmissions of any given UE.

Therefore, additionally or alternatively, the information may be communicated OTA.

The OTA signaling may be implemented through a physical control channel among network entities (e.g., gNBs).

In one or more implementations, OTA signaling may be performed over a new physical control channel, referred to as a physical network-link control channel (PNCCH) herein.

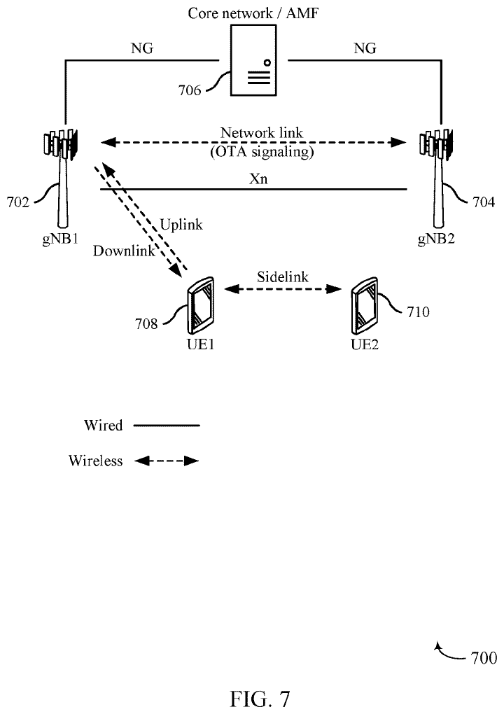

FIG. 7 illustrates an example 700 of relationship among entities and links in an example system that supports inter-user equipment cross-link interference management in accordance with aspects of the present disclosure. Wired interfaces are illustrated with a solid line, wireless interfaces are illustrated with a dashed arrowed line. The example 700 illustrates a system including network entities 702 and 704 signaling over an NG interface with a core network or AMF 706, over an Xn interface with each other, as well as OTA signaling between each other. Additionally, a UE 708 is illustrated signaling with the network entity 702 via uplink and downlink signaling, and with a UE 710 via sidelink signaling.

The physical control channel may PNCCH be mapped to one or both of existing or new transport channels and logical channels at the higher layers.

In some examples, a PNCCH may be mapped to one or both of a network-link transport channel (NCH) or a network-link logical control channel (NCCH). Additionally or alternatively, the PNCCH may be mapped to one or both of existing transport or logical channels such as common control channel (CCCH) and broadcast control channel (BCCH).

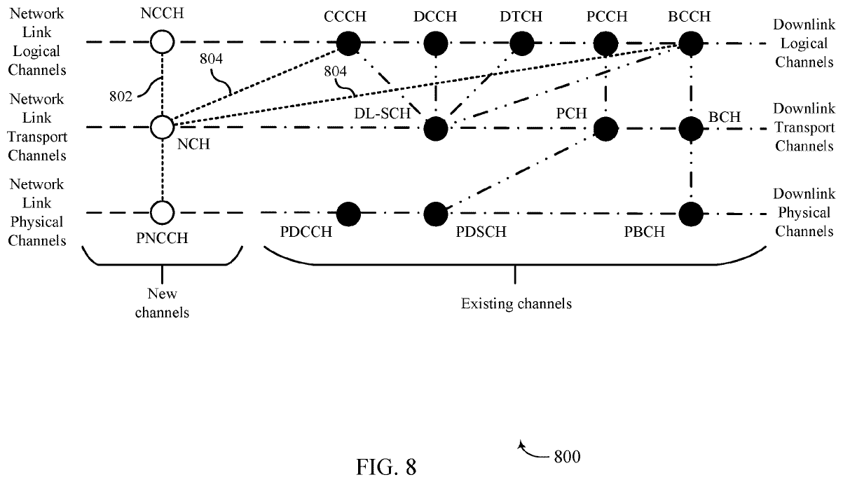

FIG. 8 illustrates an example 800 of mapping among the new and existing channels that supports inter-user equipment cross-link interference management in accordance with aspects of the present disclosure. The example 800 illustrates channel mapping for network link for inter-gNB OTA signaling. As illustrated, the PNCCH may be mapped to one or more of NCCH at 802, CCCH at 804, or BCCH at 806.

Additionally or alternatively, OTA signaling may be performed over an existing channel such as a physical downlink control channel (PDCCH). It should be noted that although downlink control signaling is normally intended for reception by UEs, the design of the PDCCH does not prevent it from being reused for transmission to other network entities (e.g., gNBs), especially if the channel can provide a faster channel in terms of one or both of higher data rate or lower latency compared to a backhaul interface such as Xn.

In either case, when a first network entity (e.g., gNB) intends to transmit physical control signals to a second network entity (e.g., gNB), the first network entity (e.g., gNB) may scramble the signals by a radio network temporary identifier (RNTI) that is known to the second network entity (e.g., gNB). The second network entity (e.g., gNB) may also be informed of other configuration information to receive the OTA signaling, for example the resources used by the first network entity (e.g., gNB) to transmit the signals.

The new RNTI is referred to as a network link RNTI (NL-RNTI) herein. In several examples, an NL-RNTI may be a new RNTI or an existing RNTI reused for scrambling OTA signaling.

In one example, an NL-RNTI may be assigned by the standard specification to any or all OTA signaling among network entities (e.g., gNBs). Then, the first network entity (e.g., gNB) scrambles the OTA signaling by the NL-RNTI and the second network entity (e.g., gNB) receives and descrambles the signals by the NL-RNTI. In this case, any or all communications among a plurality of network entities (e.g., gNBs) may be descrambled by any of the network entities (e.g., gNBs).

By extension, multiple NL-RNTIs may be assigned by the standard specification to OTA signaling among the network entities (e.g., gNBs). If no further coordination is performed, each network entity (e.g., gNB) may attempt to receive OTA signaling from any other network entities (e.g., gNBs) by descrambling signals by any or all the multiple NL-RNTIs.

In another example, multiple NL-RNTIs may be assigned by the standard specification to OTA signaling among the gNBs, but further coordination indicates which NL-RNTI is to be used for communication between or among specific network entities (e.g., gNBs). For instance, network entities (e.g., gNBs) in a cluster may use one NL-RNTI for OTA signaling among network entities (e.g., gNBs) of the cluster. In this case, each network entity (e.g., gNB) within the cluster can descramble OTA signals from any other network entity (e.g., gNB) in the cluster. This way, communications in different clusters are separated by assigning different NL-RNTIs.

In some examples, coordination for assigning an RNTI to an OTA signaling channel may be implemented by communication over a backhaul interface. In one example, the NL-RNTI may be assigned by a core network function such as an AMF over an NG interface. In this case, the AMF may indicate the NL-RNTI to one or both of the first network entity (e.g., gNB) transmitting the OTA signals or the second network entity (e.g., gNB) receiving the OTA signals.

In another example, the first network entity (e.g., gNB) transmitting the OTA signals may indicate an NL-RNTI for the OTA signaling channel to the second network entity (e.g., gNB) that is intended to receive the OTA signals. The indication may be sent over an Xn interface.

Conversely, in yet another example, the second network entity (e.g., gNB) intending to receive OTA signals from the first v may indicate an NL-RNTI for the OTA signaling channel to the first network entity (e.g., gNB). The indication may be sent over an Xn interface.

In several examples, OTA signaling is scrambled by a number cᵢₙᵢₜ consisting of two parts: an NL-RNTI and an ID. In this case, the generator of a scrambling sequence c (i) may be initiated by:

$${c}_{init} = {n}_{RNTI} \cdot {2}^{15} + {n}_{ID}$$

where n_{RNTI} is an NL-RNTI for OTA signaling and n_{ID} is an ID.

In one example, the ID may be a cell ID associated with the first network entity (e.g., gNB) transmitting the OTA signal, the second network entity (e.g., gNB) receiving the OTA signal, or a combination thereof.

In other examples, the ID may be assigned by signaling over the backhaul. In one example, the ID is assigned by a core network function such as an AMF over an NG interface. In another example, the first network entity (e.g., gNB) transmitting the OTA signals may indicate an ID, such as a cell ID associated with the first network entity (e.g., gNB), to the second network entity (e.g., gNB) intended to receive the OTA signals. In yet another example, the second network entity (e.g., gNB) intending to receive OTA signals from the first network entity (e.g., gNB) may indicate to the first network entity (e.g., gNB) an ID, such as a cell ID associated with the second network entity (e.g., gNB).

Resource assignment and other configurations for an OTA signaling control channel such as a PNCCH may follow similar principles as those for PDCCH. Information of resource assignment and other configurations may be communicated to the network entities (e.g., gNBs) over the backhaul.

In one example, a core network function such as an AMF may indicate resource assignment and other configuration information to one or both of the first network entity (e.g., gNB) or the second network entity (e.g., gNB). The indication may be signaled over one or more NG interfaces.

In another example, the first network entity (e.g., gNB) intending to transmit OTA signals may indicate, over an Xn interface, resource assignment and other configuration information for an OTA signaling control channel to the second network entity (e.g., gNB) intended to receive the OTA signals.

With respect to OTA without backhaul, in the description of several implementations and examples of OTA signaling, it is assumed that OTA signaling is used for communicating dynamic information such as pattern indication for CLI measurements, pattern indication for coordinated scheduling and beamforming, ACLR indication, and the like. However, semi-static information such as configuration of reference signals may be communicated among network entities (e.g., gNBs) and the core network over backhaul such as Xn and NG interfaces.

Additionally or alternatively, OTA signaling may also be used for exchanging semi-static configuration and indications. A first network entity (e.g., gNB) intending to transmit OTA signals may indicate information of how to receive the OTA signals or how to establish a control channel (such as a PNCCH or a PDCCH) in a broadcast system information block (SIB), master information block (MIB), or the like. In one example, a second network entity (e.g., gNB) intending to receive the OTA signals may detect synchronization signal blocks (SSBs) from the first network entity (e.g., gNB), decode one or both of MIB or SIB received from the first network entity (e.g., gNB), and then receive the OTA signals. A similar signaling may be used for communication in the opposite direction, e.g., from the second network entity (e.g., gNB) back to the first network entity (e.g., gNB).

In other examples, once the second network entity (e.g., gNB) decodes one or both of MIB or SIB received from the first network entity (e.g., gNB), the second network entity (e.g., gNB) may initiate an OTA signaling such as a random access signaling on a random-access channel (RACH) from the first network entity (e.g., gNB) to establish an OTA channel, e.g., a PNCCH or a PDCCH. The channel may then be used for two-way or one-way communication between the two network entities (e.g., gNBs). In one example, the RACH may be dedicated to OTA signaling, in which case the second network entity (e.g., gNB) need not contend with UEs for transmitting a RACH preamble to the first network entity (e.g., gNB). In another example, the second network entity (e.g., gNB) may obtain information of a RACH, used by UEs, from the physical broadcast channel (PBCH) broadcast by the first network entity (e.g., gNB).

Additionally or alternatively, semi-static information may be exchanged among network entities (e.g., gNBs) over a combination of backhaul and OTA signaling.

Methods of network entity-to-network entity (e.g., gNB-to-gNB) OTA signaling may be extended to network entity-to-UE (e.g., gNB-to-UE) OTA signaling. The following figure illustrates an OTA signaling scenario in which a UE (called UE1) receives signals from a gNB (called gNB2) that does not serve the UE.

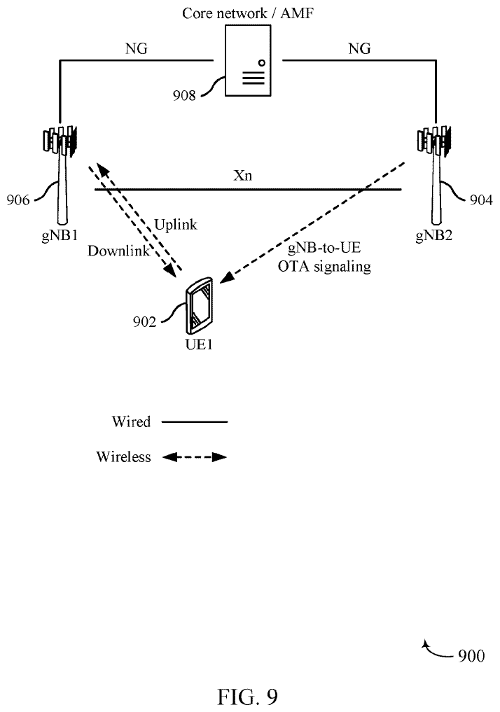

FIG. 9 illustrates an example 900 of OTA signaling by to a UE that supports inter-user equipment cross-link interference management in accordance with aspects of the present disclosure. Wired interfaces are illustrated with a solid line, wireless interfaces are illustrated with a dashed arrowed line. The example 900 illustrates OTA signaling to a UE 902 by a network entity 904 (e.g., gNB) not serving the UE 902. Network entities 904 and 906 signaling over an NG interface with a core network or AMF 908, and over an Xn interface with each other are also illustrated. Additionally, the UE 902 is also illustrated signaling with the network entity 906 via uplink and downlink signaling.

It should be noted that the difference between the ‘OTA link’ from the network entity 904 (e.g., gNB2) to the UE 902 and the downlink between the network entity 906 (e.g., gNB1) and the UE 902 is that the latter is established through initial access and RRC connection establishment. The downlink is paired with an uplink, which may be duplexed in time or frequency domains (e.g., TDD or FDD). But the OTA link is not necessarily preceded by initial access or RRC connection establishment. Instead, the UE 902 may receive signals broadcast by network entity 904 (e.g., gBN2) in several examples.

Implementations discussed herein can be extended to utilize a direct OTA link between a UE and a non-serving network entity (e.g., gNB), some examples of which are discussed below. It should be noted that extension of other scenarios, implementations, and examples not listed below are straight-forward.

With respect to extension of pattern indication for inter-UE CLI measurements among a large number of UEs, several implementations and examples may be extended to utilize a direct network entity-UE (e.g., gNB-UE) OTA link for pattern indications for inter-UE CLI measurements.

In various examples, network entity 904 (e.g., gNB2) configures an SRS for a total K UEs from which a maximum of N UEs may be indicated to transmit SRS. Network entity 904 (e.g., gNB2) then informs network entity 906 (e.g., gNB1) of the configuration, and in turn, network entity 906 (e.g., gNB1) configures the UE 902 with inter-cell inter-UE CLI (SRS-RSRP) reporting based on measuring the SRS. The UE 902 may then be informed about which UEs out of the total K UEs are to transmit SRS during a certain period.

In one or more implementations, the UE 902 is informed by backhaul signaling. In this case, the network entity 904 (e.g., gNB2) may indicate to the network entity 906 (e.g., gNB1), through backhaul signaling directly (through Xn signaling) or indirectly (through NG signaling), which UEs are to transmit SRS. For instance, the indication may include a bitmap of length K in which a maximum N bits are set to ‘1’. Having received the indication from the network entity 904 (e.g., gNB2), the network entity 906 (e.g., gNB1) may relay the information to the UE 902 by transmitting a downlink control signal such as a DCI message.

Additionally or alternatively, the UE 902 is informed by network entity-network entity (e.g., gNB-gNB) OTA signaling. In this case, the network entity 904 (e.g., gNB2) may indicate to the network entity 906 (e.g., gNB1), through an OTA signaling (e.g., a network link control channel as proposed earlier), which UEs are to transmit SRS. For instance, the indication may include a bitmap of length K in which a maximum N bits are set to ‘1’. Having received the indication from the network entity 904 (e.g., gNB2), the network entity 906 (e.g., gNB1) may relay the information to the UE 902 by transmitting a downlink control signal such as a DCI message.

Additionally or alternatively, the UE 902 is informed by network entity-UE (e.g., gNB-UE) OTA signaling. In this case, the network entity 906 (e.g., gNB1) does not have to relay information from the network entity 904 (e.g., gNB2) to the UE 902. Instead, the network entity 904 (e.g., gNB2) may broadcast a pattern indication over the air that UE 902 can receive directly.

With respect to implementing network entity-to-UE (e.g., gNB-to-UE) OTA signaling, similar to the case of network entity-network entity (e.g., gNB-gNB) OTA link, in several examples, the UE 902 may be assigned an RNTI, existing or new, by a network signaling or a standard specification. The UE 902 may then use the RNTI, in combination with an ID in several examples, to descramble and decode OTA signals from a non-serving network entity 904 (e.g., gNB2). In several examples, the ID may be a cell ID associated with the non-serving network entity 904 (e.g., gNB2), which may be signaled to the UE indirectly (e.g., through a network entity 906 (e.g., gNB1) serving the UE 902) or directly (e.g., through a signal broadcast by the non-serving network entity 904 (e.g., gNB2)).

The following should be noted with respect to the techniques discussed herein.

The different steps or acts described for the example implementations, in the text and in the flowcharts, may be permuted.

Each configuration may be provided by one or more configurations in practice. An earlier configuration may provide a subset of parameters while a later configuration may provide another subset of parameters. Additionally or alternatively, a later configuration may override values provided by an earlier configuration or a pre-configuration.

A configuration may be provided by one or more of an Xn/NG signaling, a radio resource control (RRC) signaling, a medium-access control (MAC) signaling, a physical layer signaling such as a downlink control information (DCI) message, or other methods. A configuration may include a pre-configuration or a semi-static configuration provided by at least one of the standard, the vendor, the network or operator (e.g., OAM). Each parameter value received through configuration or indication may override previous values for a similar parameter.

Despite frequent references to IAB, the techniques discussed herein may be applicable to wireless relay nodes and other types of wireless communication entities.

L1/L2 control signaling may refer to control signaling in layer 1 (physical layer) or layer 2 (data link layer). Particularly, an L1/L2 control signaling may refer to an L1 control signaling such as one or more of a DCI message or a UCI message, or an L2 control signaling such as a MAC message. A format and an interpretation of an L1/L2 control signaling may be determined by at least one of the standard, a configuration, or other control signaling.

Reference is made herein to a message or an IE. ‘IE’ is an acronym used frequently in LTE and NR specifications for referring to a configuration at layer 3 and higher. An IE may be included in a message from one layer to another layer or from one entity to another entity. Additionally or alternatively, an IE may be included in another IE. In the discussion herein, the terms ‘IE’ and ‘message’ may be used interchangeably when the message includes the IE directly or indirectly.

Any parameter discussed herein may appear, in practice, as a linear function of that parameter in signaling or specifications.

There is discussion herein to perform measurements for beam training on reference signals. Additionally or alternatively, in some implementations, a measurement may be performed on resources that are not necessarily configured for reference signals, but rather a node may measure a receive signal power and obtain a receive signal strength indicator (RSSI) or the like.

In the discussions herein, reference is frequently made to beam indication. In practice, according to a standard specification, a beam indication may refer to an indication of a reference signal by an ID or indicator, a resource associated with a reference signal, a spatial relation information including information of a reference signal or a reciprocal of a reference signal (in the case of beam correspondence).

Despite the use of SRS for inter-UE CLI measurements, other reference signals such as a new type of cross-link interference reference signals (CLI-RS) may be used for the purpose.

In some scenarios, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node, network entity) to amplify signals that are transmitted or received from one or multiple spatial directions.

In some scenarios, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices such as a CU, it can be used for signaling or local decision making.

In some scenarios, an antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some scenarios, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or include a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported/used for transmission.

In some scenarios, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, e.g., the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same Rx beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some scenarios, a TCI-state (Transmission Configuration Indication) associated with a target transmission can indicate parameters for configuring a quasi-collocation relationship between the target transmission (e.g., target RS of demodulation (DM)-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some of the implementations described, a TCI state includes at least one source RS to provide a reference (device assumption) for determining QCL and/or spatial filter.

In some scenarios, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based physical uplink shared channel (PUSCH), dedicated physical uplink control channel (PUCCH) resources) in a CC or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/physical downlink shared channel (PDSCH)) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In some scenarios, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some scenarios, a UL TCI state is provided if a device is configured with separate DL/UL TCI by RRC signaling. The UL TCI state may includes a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some scenarios, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Accordingly, in one or more implementations the techniques discussed herein introduce new signaling that allows inter-UE CLI handling by exchanging a small number of SRS configurations associated with several UEs. Methods are proposed for reducing SRS resources and joint SRS transmission and CLI measurement by a plurality of UEs, focusing on L1/L2 aspects.

Additionally or alternatively, a UE receives an SRS configuration for inter-cell CLI measurements, where the SRS configuration includes information of joint resource allocation for several UEs. The UE also receives a CLI (SRS-RSRP) reporting configuration. Then, the UE determines which resources of the jointly allocated resources are associated with a UE, or a beam of a UE, and performs CLI measurements on the resources. Measurements on resources associated with an identical UE (or an identical beam of the UE) may be combined for improving measurement accuracy. The CLI results are then reported to the serving cell to be used for scheduling and link adaptation.

Additionally or alternatively, the techniques discussed herein introduce one or both of new backhaul or OTA signaling that allows a first network entity (e.g., a first gNB) serving a victim UE to obtain additional information from a second network entity (e.g., a second gNB) serving an aggressor UE. The first network entity may then use the additional information along with the CLI results reported by the victim UE for coordinated scheduling and beamforming, link adaptation, and so on.

Additionally or alternatively, a first network entity (e.g., a first gNB) serving a victim UE receives an SRS configuration for inter-cell CLI measurements from a network entity (e.g., a second gNB) serving a plurality of aggressor UEs. Furthermore, in one or more implementations the first network entity receives additional information in association with the SRS configuration that indicates which UEs (or beams of UEs) may be used in the next P milliseconds. The first network entity may then use this information in combination with the CLI reported by the victim UE for coordinated scheduling and beamforming, link adaptation, and so on. Additionally or alternatively, the first network entity receives ACLR information from the second network entity, which along the reported CLI may be used to estimate adjacent channel interference, which then can be used for scheduling and link adaptation in an adjacent channel.

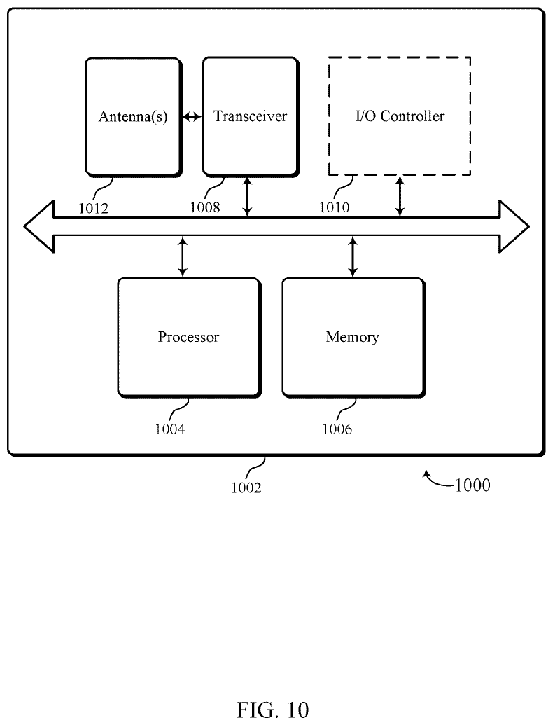

FIG. 10 illustrates an example of a block diagram 1000 of a device 1002 that supports inter-user equipment cross-link interference management in accordance with aspects of the present disclosure. The device 1002 may also be referred to as an apparatus. The device 1002 may be an example of a UE 104 as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006).

For example, the processor 1004 may support wireless communication at the device 1002 in accordance with examples as disclosed herein. Processor 1004 may be configured as or otherwise support to: receive, from a network entity, a first signaling indicating a SRS configuration for inter-cell CLI measurements, where the SRS configuration includes an indication of a set of resources associated with multiple devices; receive, from the network entity, a second signaling indicating a CLI reporting configuration associated with the SRS configuration; perform a CLI measurement on each of multiple subsets of the resources according to the CLI reporting configuration, where each of the multiple subsets is associated with one of the multiple devices; and transmit, to the network entity, a third signaling indicating a CLI report that comprises one or more results of the CLI measurements.

Additionally or alternatively, the processor 1004 may be configured to or otherwise support: where each of the multiple subsets comprises one or more of at least one symbol, or at least one resource element; where the CLI report further comprises indications of associations between each of the one or more results and one of the multiple devices; where each of the multiple subsets is further associated with a transmit beam of one of the multiple devices; where the CLI report further comprises indications of associations between each of the one or more results and a transmit beam of one of the multiple devices; where a subset of the resources associated with a device is determined by: determining a pattern associated with the device, where the pattern comprises multiple fields each of which is further associated with one of the multiple subsets; determining, in response to a field in the pattern being equal to a first value, that a resource associated with the field is in the subset; and determining, in response to the field in the pattern being equal to a second value, that the resource associated with the field is not in the subset; where: the pattern comprises, or is associated with, a bitmap field; each of the multiple fields is a bit in the bitmap field; the first value is ‘1’; and the second value is ‘0’; where the processor is configured to cause the apparatus to: receive, from the network entity, a fourth signaling indicating an activation or deactivation associated with at least one of the SRS configuration or the CLI reporting configuration; and in response to the fourth signaling indicating deactivation: not performing the CLI measurements; or not transmitting the CLI report to the network entity; where a subset of the resources associated with a device is determined by: receiving, from the network entity, a fourth signaling indicating a pattern associated with the multiple devices, where the pattern comprises multiple fields each of which is associated with one of the multiple devices; determining, in response to a field in the pattern being equal to a first value, that a device associated with the field transmits an SRS; and determining, in response to the field in the pattern being equal to a second value, that the device associated with the field does not transmit the SRS; where: the pattern comprises, or is associated with, a bitmap field; each of the multiple fields is a bit in the bitmap field; the first value is ‘1’; and the second value is and ‘0’; where the processor is configured to cause the apparatus to receive, from at least one of the network entity or an additional network entity serving at least a subset of the devices, the pattern; where: the CLI is a co-channel interference; and each of the one or more results is at least one of an SRS-RSRP or a CLI-RSSI; where: the CLI is an adjacent channel interference; each of the one or more results is a CLI-RSSI; and each of the one or more results of the CLI measurements is obtained by: measuring a co-channel interference associated with a device; obtaining an ACLR associated with the device; and computing the adjacent channel interference by combining the co-channel interference and the ACLR; where the obtaining the ACLR comprises receiving a message including a value of the ACLR; where the computing the adjacent channel interference comprises at least one of: dividing the co-channel interference by the ACLR in a real domain; or subtracting the ACLR from the co-channel interference in a logarithmic or decibel domain; where the apparatus is a UE; where each of the devices is a UE served by at least one of the network entity, or a network entity of a neighboring serving cell; where the CLI report is associated with a physical layer, a MAC layer, or a RRC layer.

For example, the processor 1004 may support wireless communication at the device 1002 in accordance with examples as disclosed herein. Processor 1004 may be configured as or otherwise support a means for receiving, from a network entity, a first signaling indicating a SRS configuration for inter-cell CLI measurements, where the SRS configuration includes an indication of a set of resources associated with multiple devices; receiving, from the network entity, a second signaling indicating a CLI reporting configuration associated with the SRS configuration; performing a CLI measurement on each of multiple subsets of the resources according to the CLI reporting configuration, where each of the multiple subsets is associated with one of the multiple devices; and transmitting, to the network entity, a third signaling indicating a CLI report that comprises one or more results of the CLI measurements.

Additionally or alternatively, the processor 1004 may be configured to or otherwise support: where each of the multiple subsets comprises one or more of at least one symbol, or at least one resource element; where the CLI report further comprises indications of associations between each of the one or more results and one of the multiple devices; where each of the multiple subsets is further associated with a transmit beam of one of the multiple devices; where the CLI report further comprises indications of associations between each of the one or more results and a transmit beam of one of the multiple devices; where a subset of the resources associated with a device is determined by: determining a pattern associated with the device, where the pattern comprises multiple fields each of which is further associated with one of the multiple subsets; determining, in response to a field in the pattern being equal to a first value, that a resource associated with the field is in the subset; and determining, in response to the field in the pattern being equal to a second value, that the resource associated with the field is not in the subset; where: the pattern comprises, or is associated with, a bitmap field; each of the multiple fields is a bit in the bitmap field; the first value is ‘1’; and the second value is ‘0’; further including: receiving, from the network entity, a fourth signaling indicating an activation or deactivation associated with at least one of the SRS configuration or the CLI reporting configuration; and in response to the fourth signaling indicating deactivation: not performing the CLI measurements; or not transmitting the CLI report to the network entity; where a subset of the resources associated with a device is determined by: receiving, from the network entity, a fourth signaling indicating a pattern associated with the multiple devices, where the pattern comprises multiple fields each of which is associated with one of the multiple devices; determining, in response to a field in the pattern being equal to a first value, that a device associated with the field transmits an SRS; and determining, in response to the field in the pattern being equal to a second value, that the device associated with the field does not transmit the SRS; where: the pattern comprises, or is associated with, a bitmap field; each of the multiple fields is a bit in the bitmap field; the first value is ‘1’; and the second value is and ‘0’; further including receiving, from at least one of the network entity or an additional network entity serving at least a subset of the devices, the pattern; where: the CLI is a co-channel interference; and each of the one or more results is at least one of an SRS-RSRP or a CLI-RSSI; where: the CLI is an adjacent channel interference; each of the one or more results is a CLI-RSSI; and each of the one or more results of the CLI measurements is obtained by: measuring a co-channel interference associated with a device; obtaining an ACLR associated with the device; and computing the adjacent channel interference by combining the co-channel interference and the ACLR; where the obtaining the ACLR comprises receiving a message including a value of the ACLR; where the computing the adjacent channel interference comprises at least one of: dividing the co-channel interference by the ACLR in a real domain; or subtracting the ACLR from the co-channel interference in a logarithmic or decibel domain; where the method is implemented by a UE; where each of the devices is a UE served by at least one of the network entity, or a network entity of a neighboring serving cell; where the CLI report is associated with a physical layer, a MAC layer, or a RRC layer. The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The processor 1004 of the device 1002, such as a UE 104, may support wireless communication in accordance with examples as disclosed herein. The processor 1004 includes at least one controller coupled with at least one memory, and is configured to or operable to cause the processor to receive, from a network entity, a first signaling indicating a sounding reference signal (SRS) configuration for inter-cell cross-link interference (CLI) measurements, wherein the SRS configuration includes an indication of a set of resources associated with multiple devices; receive, from the network entity, a second signaling indicating a CLI reporting configuration associated with the SRS configuration; perform a CLI measurement on each of multiple subsets of the resources according to the CLI reporting configuration, wherein each of the multiple subsets is associated with one of the multiple devices; and transmit, to the network entity, a third signaling indicating a CLI report that comprises one or more results of the CLI measurements.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device 1002. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor 1004. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (i.e., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

FIG. 11 illustrates an example of a block diagram 1100 of a device 1102 that supports inter-user equipment cross-link interference management in accordance with aspects of the present disclosure. The device 1102 may also be referred to as an apparatus. The device 1102 may be an example of a network entity 102 as described herein. The device 1102 may support wireless communication with one or more network entities 102, UEs 104, or any combination thereof. The device 1102 may include components for bi-directional communications including components for transmitting and receiving communications, such as a processor 1104, a memory 1106, a transceiver 1108, and an I/O controller 1110. These components may be in electronic communication or otherwise coupled (e.g., operatively, communicatively, functionally, electronically, electrically) via one or more interfaces (e.g., buses).

The processor 1104, the memory 1106, the transceiver 1108, or various combinations thereof or various components thereof may be examples of means for performing various aspects of the present disclosure as described herein. For example, the processor 1104, the memory 1106, the transceiver 1108, or various combinations or components thereof may support a method for performing one or more of the operations described herein.

In some implementations, the processor 1104, the memory 1106, the transceiver 1108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1104 and the memory 1106 coupled with the processor 1104 may be configured to perform one or more of the functions described herein (e.g., executing, by the processor 1104, instructions stored in the memory 1106).

For example, the processor 1104 may support wireless communication at the device 1102 in accordance with examples as disclosed herein. Processor 1104 may be configured as or otherwise support to: transmit, to a UE, a first signaling indicating a SRS configuration for inter-cell CLI measurements, where the SRS configuration includes an indication of a set of resources associated with multiple devices; transmit, to the UE, a second signaling indicating a CLI reporting configuration associated with the SRS configuration; and receive, from the UE, a third signaling indicating a CLI report that comprises one or more results of CLI measurements performed on each of multiple subsets of the resources according to the CLI reporting configuration, where each of the multiple subsets is associated with one of the multiple devices.

Additionally or alternatively, the processor 1104 may be configured to or otherwise support: where each of the multiple subsets comprises one or more of at least one symbol, or at least one resource element; where the CLI report further comprises indications of associations between each of the one or more results and one of the multiple devices; where each of the multiple subsets is further associated with a transmit beam of one of the multiple devices; where the CLI report further comprises indications of associations between each of the one or more results and a transmit beam of one of the multiple devices; where the processor is configured to cause the apparatus to: transmit, to the UE, a fourth signaling indicating an activation or deactivation associated with at least one of the SRS configuration or the CLI reporting configuration; where: the CLI is a co-channel interference; and each of the one or more results is at least one of an SRS-RSRP or a CLI-RSSI; where the apparatus is a network entity; where each of the devices is a UE served by at least one of the apparatus, or a network entity of a neighboring serving cell; where the CLI report is associated with a physical layer, a MAC layer, or a RRC layer.

For example, the processor 1104 may support wireless communication at the device 1102 in accordance with examples as disclosed herein. Processor 1104 may be configured as or otherwise support a means for transmitting, to a UE, a first signaling indicating a SRS configuration for inter-cell CLI measurements, where the SRS configuration includes an indication of a set of resources associated with multiple devices; transmitting, to the UE, a second signaling indicating a CLI reporting configuration associated with the SRS configuration; and receiving, from the UE, a third signaling indicating a CLI report that comprises one or more results of CLI measurements performed on each of multiple subsets of the resources according to the CLI reporting configuration, where each of the multiple subsets is associated with one of the multiple devices.

Additionally or alternatively, the processor 1104 may be configured to or otherwise support: where each of the multiple subsets comprises one or more of at least one symbol, or at least one resource element; where the CLI report further comprises indications of associations between each of the one or more results and one of the multiple devices; where each of the multiple subsets is further associated with a transmit beam of one of the multiple devices; where the CLI report further comprises indications of associations between each of the one or more results and a transmit beam of one of the multiple devices; further including: transmitting, to the UE, a fourth signaling indicating an activation or deactivation associated with at least one of the SRS configuration or the CLI reporting configuration; where: the CLI is a co-channel interference; and each of the one or more results is at least one of an SRS-RSRP or a CLI-RSSI; where the method is implemented by a network entity; where each of the devices is a UE served by at least one of an apparatus implementing the method, or a network entity of a neighboring serving cell; where the CLI report is associated with a physical layer, a MAC layer, or a RRC layer. The processor 1104 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1104 may be configured to operate a memory array using a memory controller. In some other implementations, a memory controller may be integrated into the processor 1104. The processor 1104 may be configured to execute computer-readable instructions stored in a memory (e.g., the memory 1106) to cause the device 1102 to perform various functions of the present disclosure.

For example, the processor 1104 may support wireless communication at the device 1102 in accordance with examples as disclosed herein. Processor 1104 may be configured as or otherwise support a means for receiving, from a network entity, a first signaling indicating a SRS configuration that indicates an association between multiple resources and multiple devices; transmitting, to a first device, a second signaling indicating a CLI reporting configuration; receiving, from the first device, a third signaling indicating a CLI report in accordance with the CLI reporting configuration, where the CLI report comprises multiple CLI measurement results associated with the multiple resources; and transmitting, to the network entity, a fourth signaling indicating a CLI report IE that indicates that one or more of the multiple devices cause an excessive CLI based on the CLI report and the association between the multiple resources and the multiple devices.

Additionally or alternatively, the processor 1104 may be configured to or otherwise support: where the one or more of the multiple devices that cause the excessive CLI is determined by: determining that one or more CLI measurement results associated with one or more of the multiple resources are excessive; determining one or multiple of the multiple devices associated with the one or multiple of the multiple resources based on the association between the multiple resources and the multiple devices; and inferring that the one or more of the devices cause the excessive CLI; where the determining that the one or more CLI measurement results are excessive comprises comparing the CLI measurement results with a CLI threshold; where each of the multiple resources comprises one or more of at least one symbol, or at least one resource element; where: the SRS configuration further comprises an indication of an association between the multiple resources and multiple transmit beams of the multiple devices; the method further comprises determining that one or more of the multiple transmit beams of one or more of the multiple devices cause the excessive CLI; and the CLI report IE further indicates that the one or more of the multiple transmit beams of the one or more devices cause the excessive CLI; further including: receive an activation or deactivation indication associated with the SRS configuration; and indicating to the first device, in response to determining that the activation or deactivation indication indicates deactivation, to deactivate CLI reporting; where the one or more of the multiple devices that cause the excessive CLI is determined by: receiving a pattern, from the network entity, associated with the multiple devices, where the pattern comprises multiple fields each of which is associated with one of the multiple devices; determining, in response to a field in the pattern being equal to a first value, that a device associated with the field transmits an SRS; and determining, in response to the field in the pattern being equal to a second value, that the device does not transmit the SRS; where: the pattern comprises, or is otherwise associated with, a bitmap field; each of the multiple fields is a bit in the bitmap field; the first value is ‘1’; and the second value is ‘0’; further including receiving the pattern via a fifth signaling over one or more of a backhaul interface, or over the air (OTA); where each of the multiple CLI measurement results is at least one of a co-channel SRS-RSRP or a co-channel CLI-RSSI; where: each of the multiple CLI measurement results is a co-channel SRS-RSRP; and the one or more of the multiple devices that cause the excessive CLI is obtained by: obtaining one or more ACLR values associated with the one or more of the multiple devices; and computing adjacent channel CLIs by combining the co-channel SRS-RSRP and ACLR values; further including receiving, from the network entity, a fifth signaling indicating the ACLR values; where computing an adjacent channel CLI comprises at least one of: dividing the co-channel SRS-RSRP values by the associated ACLR values in a real domain; or subtracting the ACLR values from the co-channel SRS-RSRP values in a logarithmic or decibel domain; where each of an apparatus implementing the method and the network entity is a base station or a TRP; where the CLI threshold is indicated by a core network function, by an OAM entity, by a standard, or according to an implementation; where the CLI report is associated with a physical layer, a MAC layer, or a RRC layer.

For example, the processor 1104 may support wireless communication at the device 1102 in accordance with examples as disclosed herein. Processor 1104 may be configured as or otherwise support a means for obtaining a RNTI associated with a PNCCH; receiving, from a network entity, multiple OTA signals associated with the PNCCH; and descrambling the multiple OTA signals by applying the RNTI.

Additionally or alternatively, the processor 1104 may be configured to or otherwise support: where the RNTI is indicated by at least one of a standard, by a core network, by the network entity over a backhaul interface, by the network entity in a broadcast signal, by the network entity in a system information block, or by an OAM entity; further including: obtaining an ID; descrambling the multiple OTA signals by applying the RNTI and the ID; where the ID is a cell ID associated with the network entity; where to obtain the ID is to receive, from at least one of a core network, the network entity, or an OAB, an additional signaling indicating the ID; where the PNCCH is mapped to at least one of a NCH, a NCCH, a CCCH, or a BCCH.

For example, the processor 1104 may support wireless communication at the device 1102 in accordance with examples as disclosed herein. Processor 1104 may be configured as or otherwise support a means for transmitting, to a network entity, a first signaling indicating a SRS configuration that indicates an association between multiple resources and multiple devices; and receiving, from the network entity, a second signaling indicating a CLI report IE that indicates that one or more of the multiple devices cause an excessive CLI based on the CLI report and the association between the multiple resources and the multiple devices.

Additionally or alternatively, the processor 1104 may be configured to or otherwise support: where each of the multiple resources comprises one or more of at least one symbol, or at least one resource element; where: the SRS configuration further comprises an indication of an association between the multiple resources and multiple transmit beams of the multiple devices; and the CLI report IE further indicates that the one or more of the multiple transmit beams of the one or more devices cause the excessive CLI; further including: transmitting an activation or deactivation indication associated with the SRS configuration; further including transmitting, to the network entity, a third signaling indicating one or more ACLR values associated with the one or more of the multiple devices; where each of an apparatus implementing the method and the network entity is a base station or a TRP; where the CLI report is associated with a physical layer, a MAC layer, or a RRC layer.

For example, the processor 1104 may support wireless communication at the device 1102 in accordance with examples as disclosed herein. Processor 1104 may be configured as or otherwise support a means for scrambling, by applying a RNTI associated with a PNCCH, multiple OTA signals associated with the PNCCH; and transmitting, to a network entity, the multiple OTA.

Additionally or alternatively, the processor 1104 may be configured to or otherwise support: where the RNTI is indicated by at least one of a standard, by a core network, by the network entity over a backhaul interface, by the network entity in a broadcast signal, by the network entity in a system information block, or by an OAM entity; further including: obtaining an ID; scrambling the multiple OTA signals by applying the RNTI and the ID; where the ID is a cell ID associated with an apparatus implementing the method; where the PNCCH is mapped to at least one of a NCH, a NCCH, a CCCH, or a BCCH.

The memory 1106 may include random access memory (RAM) and read-only memory (ROM). The memory 1106 may store computer-readable, computer-executable code including instructions that, when executed by the processor 1104 cause the device 1102 to perform various functions described herein. The code may be stored in a non-transitory computer-readable medium such as system memory or another type of memory. In some implementations, the code may not be directly executable by the processor 1104 but may cause a computer (e.g., when compiled and executed) to perform functions described herein. In some implementations, the memory 1106 may include, among other things, a basic I/O system (BIOS) which may control basic hardware or software operation such as the interaction with peripheral components or devices.

The I/O controller 1110 may manage input and output signals for the device 1102. The I/O controller 1110 may also manage peripherals not integrated into the device 1102. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. In some implementations, the I/O controller 1110 may be implemented as part of a processor, such as the processor 1104. In some implementations, a user may interact with the device 1102 via the I/O controller 1110 or via hardware components controlled by the I/O controller 1110.

In some implementations, the device 1102 may include a single antenna 1112. However, in some other implementations, the device 1102 may have more than one antenna 1112 (i.e., multiple antennas), including multiple antenna panels or antenna arrays, which may be capable of concurrently transmitting or receiving multiple wireless transmissions. The transceiver 1108 may communicate bi-directionally, via the one or more antennas 1112, wired, or wireless links as described herein. For example, the transceiver 1108 may represent a wireless transceiver and may communicate bi-directionally with another wireless transceiver. The transceiver 1108 may also include a modem to modulate the packets, to provide the modulated packets to one or more antennas 1112 for transmission, and to demodulate packets received from the one or more antennas 1112.

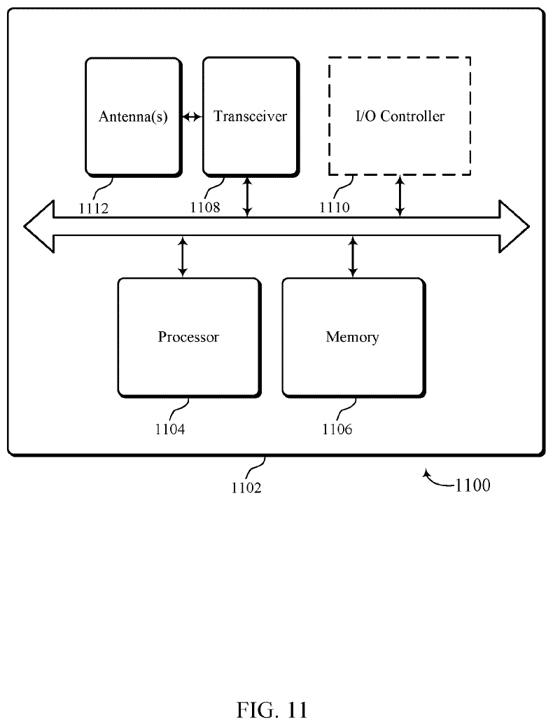

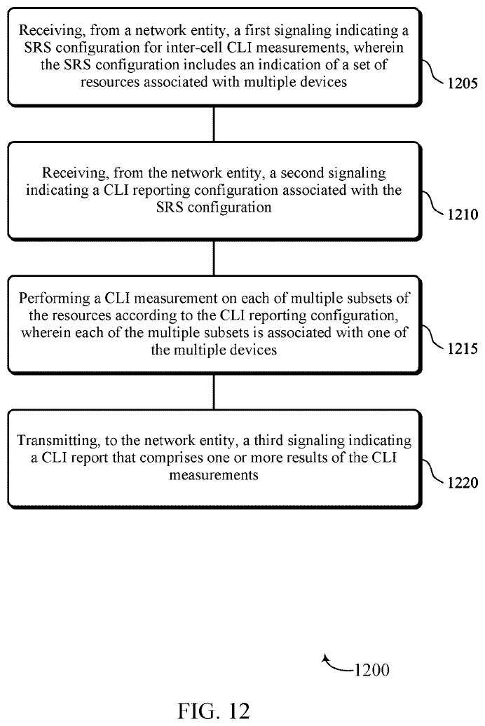

FIG. 12 illustrates a flowchart of a method 1200 that supports inter-user equipment cross-link interference management in accordance with aspects of the present disclosure. The operations of the method 1200 may be implemented by a device or its components as described herein. For example, the operations of the method 1200 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1205, the method may include receiving, from a network entity, a first signaling indicating a SRS configuration for inter-cell CLI measurements, wherein the SRS configuration includes an indication of a set of resources associated with multiple devices. The operations of 1205 may be performed in accordance with examples as described herein. In some implementations, aspects of the operations of 1205 may be performed by a device as described with reference to FIG. 1.

At 1210, the method may include receiving, from the network entity, a second signaling indicating a CLI reporting configuration associated with the SRS configuration. The operations of 1210 may be performed in accordance with examples as described herein. In some implementations, aspects of the operations of 1210 may be performed by a device as described with reference to FIG. 1.

At 1215, the method may include performing a CLI measurement on each of multiple subsets of the resources according to the CLI reporting configuration, wherein each of the multiple subsets is associated with one of the multiple devices. The operations of 1215 may be performed in accordance with examples as described herein. In some implementations, aspects of the operations of 1215 may be performed by a device as described with reference to FIG. 1.

At 1220, the method may include transmitting, to the network entity, a third signaling indicating a CLI report that comprises one or more results of the CLI measurements. The operations of 1220 may be performed in accordance with examples as described herein. In some implementations, aspects of the operations of 1220 may be performed by a device as described with reference to FIG. 1.

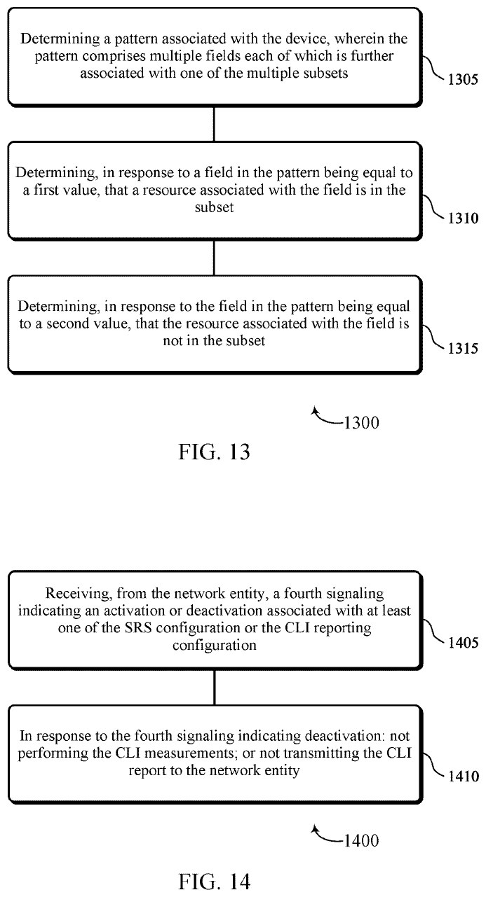

FIG. 13 illustrates a flowchart of a method 1300 that supports inter-user equipment cross-link interference management in accordance with aspects of the present disclosure. The operations of the method 1300 may be implemented by a device or its components as described herein. For example, the operations of the method 1300 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1305, the method may include determining a pattern associated with the device, wherein the pattern comprises multiple fields each of which is further associated with one of the multiple subsets. The operations of 1305 may be performed in accordance with examples as described herein. In some implementations, aspects of the operations of 1305 may be performed by a device as described with reference to FIG. 1.

At 1310, the method may include determining, in response to a field in the pattern being equal to a first value, that a resource associated with the field is in the subset. The operations of 1310 may be performed in accordance with examples as described herein. In some implementations, aspects of the operations of 1310 may be performed by a device as described with reference to FIG. 1.

At 1315, the method may include determining, in response to the field in the pattern being equal to a second value, that the resource associated with the field is not in the subset. The operations of 1315 may be performed in accordance with examples as described herein. In some implementations, aspects of the operations of 1315 may be performed by a device as described with reference to FIG. 1.

FIG. 14 illustrates a flowchart of a method 1400 that supports inter-user equipment cross-link interference management in accordance with aspects of the present disclosure. The operations of the method 1400 may be implemented by a device or its components as described herein. For example, the operations of the method 1400 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1405, the method may include receiving, from the network entity, a fourth signaling indicating an activation or deactivation associated with at least one of the SRS configuration or the CLI reporting configuration. The operations of 1405 may be performed in accordance with examples as described herein. In some implementations, aspects of the operations of 1405 may be performed by a device as described with reference to FIG. 1.

At 1410, the method may include in response to the fourth signaling indicating deactivation: not performing the CLI measurements; or not transmitting the CLI report to the network entity. The operations of 1410 may be performed in accordance with examples as described herein. In some implementations, aspects of the operations of 1410 may be performed by a device as described with reference to FIG. 1.

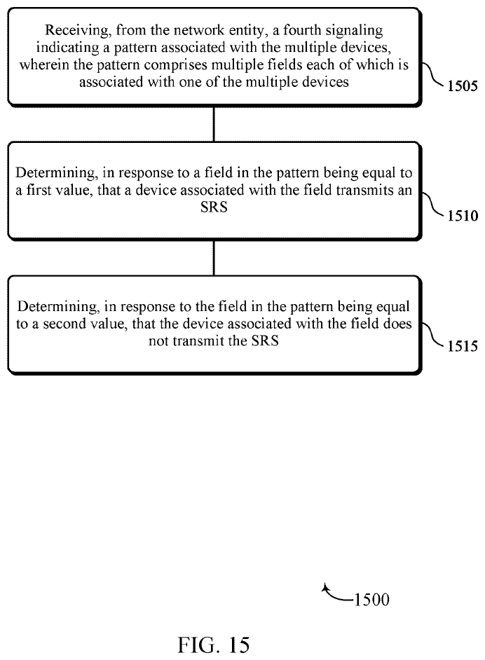

FIG. 15 illustrates a flowchart of a method 1500 that supports inter-user equipment cross-link interference management in accordance with aspects of the present disclosure. The operations of the method 1500 may be implemented by a device or its components as described herein. For example, the operations of the method 1500 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1505, the method may include receiving, from the network entity, a fourth signaling indicating a pattern associated with the multiple devices, wherein the pattern comprises multiple fields each of which is associated with one of the multiple devices. The operations of 1505 may be performed in accordance with examples as described herein. In some implementations, aspects of the operations of 1505 may be performed by a device as described with reference to FIG. 1.

At 1510, the method may include determining, in response to a field in the pattern being equal to a first value, that a device associated with the field transmits an SRS. The operations of 1510 may be performed in accordance with examples as described herein. In some implementations, aspects of the operations of 1510 may be performed by a device as described with reference to FIG. 1.

At 1515, the method may include determining, in response to the field in the pattern being equal to a second value, that the device associated with the field does not transmit the SRS. The operations of 1515 may be performed in accordance with examples as described herein. In some implementations, aspects of the operations of 1515 may be performed by a device as described with reference to FIG. 1.

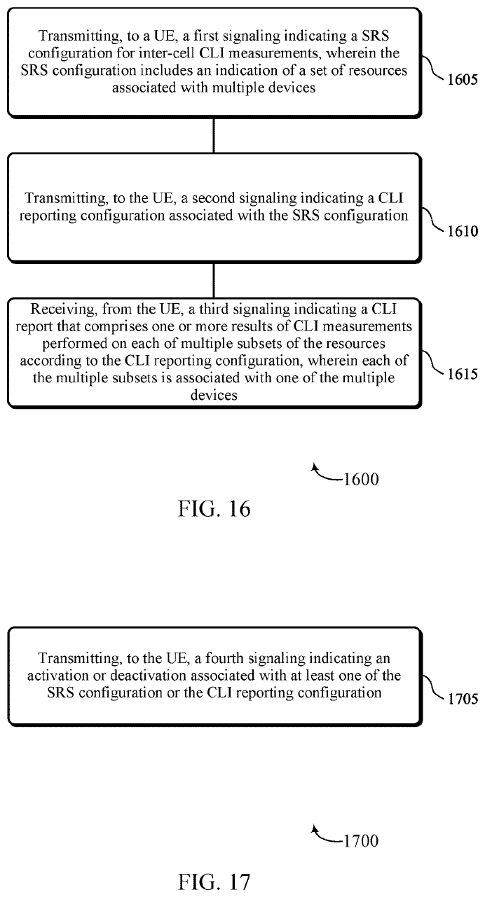

FIG. 16 illustrates a flowchart of a method 1600 that supports inter-user equipment cross-link interference management in accordance with aspects of the present disclosure. The operations of the method 1600 may be implemented by a device or its components as described herein. For example, the operations of the method 1600 may be performed by a network entity 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1605, the method may include transmitting, to a UE, a first signaling indicating a SRS configuration for inter-cell CLI measurements, wherein the SRS configuration includes an indication of a set of resources associated with multiple devices. The operations of 1605 may be performed in accordance with examples as described herein. In some implementations, aspects of the operations of 1605 may be performed by a device as described with reference to FIG. 1.

At 1610, the method may include transmitting, to the UE, a second signaling indicating a CLI reporting configuration associated with the SRS configuration. The operations of 1610 may be performed in accordance with examples as described herein. In some implementations, aspects of the operations of 1610 may be performed by a device as described with reference to FIG. 1.

At 1615, the method may include receiving, from the UE, a third signaling indicating a CLI report that comprises one or more results of CLI measurements performed on each of multiple subsets of the resources according to the CLI reporting configuration, wherein each of the multiple subsets is associated with one of the multiple devices. The operations of 1615 may be performed in accordance with examples as described herein. In some implementations, aspects of the operations of 1615 may be performed by a device as described with reference to FIG. 1.

FIG. 17 illustrates a flowchart of a method 1700 that supports inter-user equipment cross-link interference management in accordance with aspects of the present disclosure. The operations of the method 1700 may be implemented by a device or its components as described herein. For example, the operations of the method 1700 may be performed by a network entity 102 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1705, the method may include transmitting, to the UE, a fourth signaling indicating an activation or deactivation associated with at least one of the SRS configuration or the CLI reporting configuration. The operations of 1705 may be performed in accordance with examples as described herein. In some implementations, aspects of the operations of 1705 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of one or both of A or B means A or B or AB. Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a sounding reference signal (SRS) configuration for inter-cell cross-link interference (CLI) measurements, wherein the SRS configuration includes an indication of a set of resources associated with multiple devices;
receive a CLI reporting configuration associated with the SRS configuration;
perform a CLI measurement on each of multiple subsets of the resources according to the CLI reporting configuration, wherein each of the multiple subsets is associated with one of the multiple devices; and
transmit a CLI report that comprises one or more results of the CLI measurements.

2. The UE of claim 1, wherein each of the multiple subsets comprises one or more of at least one symbol, or at least one resource element.

3. The UE of claim 1, wherein the CLI report further comprises indications of associations between each of the one or more results and one of the multiple devices.

4. The UE of claim 1, wherein each of the multiple subsets is further associated with a transmit beam of one of the multiple devices.

5. The UE of claim 1, wherein the CLI report further comprises indications of associations between each of the one or more results and a transmit beam of one of the multiple devices.

6. The UE of claim 1, wherein to determine a subset of the resources associated with a device, the at least one processor is operable to cause the UE to:
determine a pattern associated with the device, wherein the pattern comprises multiple fields each of which is further associated with one of the multiple subsets;
determine, in response to a field in the pattern being equal to a first value, that a resource associated with the field is in the subset; and
determine, in response to the field in the pattern being equal to a second value, that the resource associated with the field is not in the subset.

7. The UE of claim 6, wherein:
the pattern comprises, or is associated with, a bitmap field;
each of the multiple fields is a bit in the bitmap field;
the first value is ‘1’; and
the second value is ‘0’.

8. The UE of claim 1, wherein the at least one processor is further operable to cause the UE to:
receive an activation or deactivation associated with at least one of the SRS configuration or the CLI reporting configuration; and
in response to receipt of deactivation:
not perform the CLI measurements; or
not transmit the CLI report.

9. The UE of claim 1, wherein to determine a subset of the resources associated with a device, the at least one processor is operable to cause the UE to:
receive a pattern associated with the multiple devices, wherein the pattern comprises multiple fields each of which is associated with one of the multiple devices;
determine, in response to a field in the pattern being equal to a first value, that a device associated with the field transmits an SRS; and
determine, in response to the field in the pattern being equal to a second value, that the device associated with the field does not transmit the SRS.

10. The UE of claim 9, wherein:
the pattern comprises, or is associated with, a bitmap field;
each of the multiple fields is a bit in the bitmap field;
the first value is ‘1’; and
the second value is and ‘0’.

11. The UE of claim 9, wherein the at least one processor is further operable to cause the UE to receive, from at least one of a network entity from which the SRS configuration is received or an additional network entity serving at least a subset of the multiple devices, the pattern.

12. The UE of claim 1, wherein:
the CLI is a co-channel interference; and
each of the one or more results is at least one of an SRS reference signal receive power (SRS-RSRP) or a CLI receive signal strength indication (CLI-RSSI).

13. The UE of claim 1, wherein:
the CLI is an adjacent channel interference;
each of the one or more results is a CLI receive signal strength indication (CLI-RSSI); and
to obtain each of the one or more results of the CLI measurements, the at least one processor is operable to cause the UE to:
measure a co-channel interference associated with a device;
obtain an adjacent channel leakage ratio (ACLR) associated with the device; and
compute the adjacent channel interference by combining the co-channel interference and the ACLR.

14. The UE of claim 13, wherein to obtain the ACLR, the at least one processor is operable to cause the UE to receive a message comprising a value of the ACLR.

15. The UE of claim 13, wherein to compute the adjacent channel interference, the at least one processor is operable to cause the UE to at least one of:
divide the co-channel interference by the ACLR in a real domain; or
subtract the ACLR from the co-channel interference in a logarithmic or decibel domain.

16. A base station for wireless communication, comprising:
at least one memory; and
at least one processor coupled with the at least one memory and operable to cause the base station to:
transmit a sounding reference signal (SRS) configuration for inter-cell cross-link interference (CLI) measurements, wherein the SRS configuration includes an indication of a set of resources associated with multiple devices;
transmit a CLI reporting configuration associated with the SRS configuration; and
receive a CLI report that comprises one or more results of CLI measurements performed on each of multiple subsets of the resources according to the CLI reporting configuration, wherein each of the multiple subsets is associated with one of the multiple devices.

17. A method performed by a user equipment (UE), comprising:
receiving a sounding reference signal (SRS) configuration for inter-cell cross-link interference (CLI) measurements, wherein the SRS configuration includes an indication of a set of resources associated with multiple devices;
receiving a CLI reporting configuration associated with the SRS configuration;
performing a CLI measurement on each of multiple subsets of the resources according to the CLI reporting configuration, wherein each of the multiple subsets is associated with one of the multiple devices; and
transmitting a CLI report that comprises one or more results of the CLI measurements.

18-20. (canceled)

21. The method of claim 17, further comprising determining a subset of the resources associated with a device by:
determining a pattern associated with the device, wherein the pattern comprises multiple fields each of which is further associated with one of the multiple subsets;
determining, in response to a field in the pattern being equal to a first value, that a resource associated with the field is in the subset; and
determining, in response to the field in the pattern being equal to a second value, that the resource associated with the field is not in the subset.

22. A method performed by a base station, comprising:
transmitting a sounding reference signal (SRS) configuration for inter-cell cross-link interference (CLI) measurements, wherein the SRS configuration includes an indication of a set of resources associated with multiple devices;
transmitting a CLI reporting configuration associated with the SRS configuration; and
receiving a CLI report that comprises one or more results of CLI measurements performed on each of multiple subsets of the resources according to the CLI reporting configuration, wherein each of the multiple subsets is associated with one of the multiple devices.

23. The method of claim 22, wherein:
the CLI is a co-channel interference; and
each of the one or more results is at least one of an SRS reference signal receive power (SRS-RSRP) or a CLI receive signal strength indication (CLI-RSSI).
